(19) United States
(12) Patent Application Publication
(10) Pub. No.: US 2016/0172678 A1
(43) Pub. Date: Jun. 16, 2016

(54) BINDER FOR NON-AQUEOUS ELECTRICITY STORAGE ELEMENT, AND NON-AQUEOUS ELECTRICITY STORAGE ELEMENT

(71) Applicant: KYORITSU CHEMICAL & CO., LTD., Tokyo (JP)

(72) Inventors: Naoto Oyama, Chiba (JP); Taichi Uemura, Chiba (JP)

(73) Assignee: KYORITSU CHEMICAL & CO., LTD., Tokyo (JP)

(21) Appl. No.: 14/908,644

(22) PCT Filed: Jul. 30, 2014
(86) PCT No.: PCT/JP2014/070129

§ 371 Date: Jan. 29, 2016

(30) Foreign Application Priority Data
Aug. 1, 2013 (JP) 2013-160789

(51) Int. Cl. H01M 4/62; H01G 11/30; H01G 11/68; H01G 11/52

(52) U.S. Cl. CPC H01M 4/622; H01G 11/52; H01G 11/30; H01G 11/68

(57) ABSTRACT

The present invention provides a binder that can form a layer that does not reduce high-speed charge/discharge characteristics of a non-aqueous electricity storage element while improving adhesive properties with respect to a substrate such as an electrode or a separator.

A binder for a non-aqueous electricity storage element comprising a binder containing a polymer represented by formula (1); a non-aqueous electricity storage element electrode, separator, or current collector in which the binder is used; and a non-aqueous electricity storage element provided with at least one of the non-aqueous electricity storage element electrode, separator, or current collector.

### TECHNICAL FIELD

The present invention relates to a binder for a non-aqueous electricity storage element, a non-aqueous electricity storage element electrode, separator, or current collector which is obtained by using the binder, and a non-aqueous electricity storage element provided with at least one of the non-aqueous electricity storage element electrode, separator, or current collector.

### BACKGROUND ART

Since a non-aqueous electricity storage element can obtain a higher voltage compared to the case of an aqueous electricity storage element, the non-aqueous electricity storage element can accumulate energy with high energy density and thus is highly useful as a power source for mobile devices or automobiles. For example, lithium ion primary batteries and secondary batteries have been widely used as power sources for mobile electronic devices, such as mobile phones and laptops, and electric double-layer capacitors have been used as power sources for electric tools and energy regeneration devices for heavy machines. Furthermore, calcium ion primary batteries and secondary batteries, magnesium ion primary batteries and secondary batteries, sodium ion primary batteries and secondary batteries, and the like also have potential as electricity storage elements achieving both high voltage and high energy density. However, since these non-aqueous electricity storage elements use combustible substances as electrolytic solutions, a risk of causing fire or explosion due to heat generated by a short circuit between a positive electrode and a negative electrode exists, and thus ensuring safety is a crucial issue.

An example of current measures to ensure safety is a shutdown function that shuts off ionic conduction by closing pores of a separator formed from polyolefin when the electricity storage element generates heat. When a malfunction, such as a short circuit between a positive electrode and a negative electrode, is caused in a battery, generation of heat is suppressed due to the effect of such a shutdown function, and thus thermal runaway can be prevented.

However, the melting point of a separator made of polyolefin is 200° C. or lower, and when generation of heat is intensive, the separator shrinks and thus has a risk of causing thermal runaway by bringing the positive electrode and the negative electrode into direct contact. Furthermore, since the separator made of polyolefin is softer than active materials and/or foreign metals and is very thin, having a thickness of approximately 10 to 30 μm, if shedding of active materials or contamination with foreign metals occurs during the production process of electricity storage elements, a risk of causing electrical contact of the positive electrode and the negative electrode by tearing the separator exists. Therefore, safety of non-aqueous electricity storage elements is not satisfactory, and further enhancement in safety has been demanded.

As a measure to improve the issues described above, a method of preventing shedding of active materials from an electrode by forming a highly heat resistant, porous membrane layer on an active material-coated layer that is coated on a current collector has been devised (Patent Document 1). Since this porous membrane has inorganic fillers as its frame, even when a separator with low melting point shrinks by being melted due to increase in temperature caused by a short circuit, contact between the positive electrode and the negative electrode can be prevented to suppress thermal runaway. Therefore, this porous membrane is effective as a heat resistant coating layer. Furthermore, even when an active material and/or foreign metal is mixed, the piercing strength of the membrane of firm inorganic fillers is high, and the effect of preventing separator from being torn and pierced is achieved.

Furthermore, such a heat resistant coating layer serves as a layer for suppressing generation of dendrite and for maintaining electrolytic solution. In addition, an effect of preventing deterioration of the active material layer in the case of long-term use is also achieved because the heat resistant coating layer buffers and uniformizes the acceleration of local deterioration that is due to the concentration of electrode reaction involved with unevenness of the electrode surface.

In a heat resistant coating layer, a rubber resin having resistance to an electrolytic solution as well as polyvinylidene fluoride have been proposed (Patent Document 2).

Furthermore, a binder having a hydrophilic group and a hydrophobic group to form a heat resistant coating layer has been proposed and used for producing a composition for forming a heat resistant layer by mixing this binder, inorganic particles, and a solvent (Patent Document 3).

Other than such a binder, a binder for active materials and a binder for a base treatment agent for current collectors have been proposed; and in addition to the heat resistant coating layer composition described above, various compositions such as compositions containing an active material and a binder, and base treatment agent compositions have been proposed (Patent Documents 4 and 5).

Furthermore, since a problem of deteriorating charge/discharge characteristics and/or battery life exists when water is introduced inside of a battery, produced parts are required to have low water content (Patent Document 6).

### PRIOR ART DOCUMENTS

### Patent Documents

Patent Document 1: Japanese Patent Application Kokai Publication No. 117-220759 (unexamined, published Japanese patent application)

Patent Document 2: Japanese Patent Application Kokai Publication No. 2009-54455 (unexamined, published Japanese patent application)

Patent Document 3: Japanese Patent Kohyo Publication No. 2010-520095

Patent Document 4: Japanese Patent Application Kokai Publication No. H8-157677 (unexamined, published Japanese patent application)

Patent Document 5: Japanese Patent Application Kokai Publication No. 2010-146726 (unexamined, published Japanese patent application)

Patent Document 6: Japanese Patent Application Kokai Publication No. 2010-232048 (unexamined, published Japanese patent application)

### SUMMARY OF THE INVENTION

### Problems to be Solved by the Invention

However, with conventional technologies described above, in the case where hydrophilic groups are introduced into a binder to enhance resistance to electrolytic solution, when a layer is formed on a substrate such as an electrode, separator, and current collector using a composition containing the binder, water content in the layer tend to be high. The water content of the layer can be reduced by introducing hydrophobic groups; however, such introduction tends to deteriorate the resistance to electrolytic solution. Furthermore, if the difference in polarities of the hydrophilic groups and the hydrophobic groups is extremely large and if the balance between the polarities is poor, the layer is easily released from the substrate and tends to have high water content.

The causes of these are thought to be as follows. When the composition is applied to the substrate, if wettability to the substrate surface is not sufficiently ensured, the composition is repelled by the substrate surface, and adhesive properties of the formed layer tend to be insufficient.

Furthermore, when the binder has both the hydrophilic groups and the hydrophobic groups, the hydrophilic groups enclose a water molecule, and the hydrophobic groups further enclose therearound, thereby making it difficult for water to be removed. As a result, water content tends to be high. This water reacts with the electrode active material and/or electrolytic solution component and thus tends to deteriorate characteristics of the non-aqueous electricity storage element.

As described above, when a layer is formed by using a conventional composition, adhesion between the substrate and the layer becomes insufficient and water content of the layer tends to be high. In the case where such a layer is used in a non-aqueous electricity storage element, there are a problem in which heat resistance cannot be maintained due to shedding of the layer and a problem in which the life of the non-aqueous electricity storage element is shortened by causing a reaction with water, in addition to causing deterioration in charge/discharge characteristics.

An object of the present invention is to provide a binder that is used to form a layer having a low water content and having excellent adhesion to substrates such as electrodes, separators, and current collectors, and preferably to provide a binder that is used to form a layer also having heat resistance. Since a layer formed using the binder of the present invention has excellent adhesion to substrates and has a low water content, shortening of the life of a non-aqueous electricity storage element and deterioration of high-speed charge/discharge characteristics can be avoided.

Other objects of the present invention are to provide a non-aqueous electricity storage element electrode, separator, or current collector in which the binder is used, and to provide a non-aqueous electricity storage element having at least one of the non-aqueous electricity storage element electrode, separator, or current collector.

Note that a layer formed on a surface of a substrate, such as electrode, separator, or current collector, using the binder of the present invention is referred to as “coating layer”. At least a part of coating layer may be incorporated into a substrate. The binder of the present invention can be used to form not only the coating layer but also an active material layer. The term “layer” refers to both “material layer” and “coating layer”.

### Means for Solving the Problems

The inventors of the present invention have found that, as a binder, a layer having excellent adhesion to substrates, such as electrodes, separators, and current collectors, and having a low water content can be formed by using a polymer having a unit derived from a compound having a particular functional group, and further found that it is possible to impart heat resistance to the layer. Therefore, the present invention has been completed.

The summary of the present invention is as follows.

The present invention 1 relates to

a binder for a non-aqueous electricity storage element including a polymer represented by formula (1):

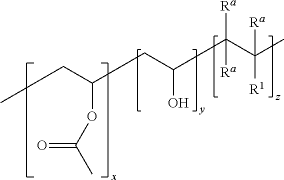

in the formula,

R¹ independently represents an alkyl group that is unsubstituted or substituted with a halogen atom and/or a hydroxy group and that has 1 to 40 carbon atoms (—CH₂— in the alkyl group may be substituted with a group selected from an oxygen atom, sulfur atom, or cycloalkanediyl); or represents a group represented by —OR² (R² is a monovalent group of a 3 to 10 membered carbocyclic ring or heterocycle);

when a sum of x, y, and z is 1,

0≦x<1, 0≦y<1, and 0<z<1 are satisfied, and

units shown in parentheses having x, y, or z may be present in a block or present randomly; and

R^{a} is independently a hydrogen atom or fluorine atom.

In formula (1), preferably 0≦x<0.5, 0≦y<1, and 0<z<1 are satisfied, and more preferably 0≦x<0.1, 0≦y<1, and 0<z<1 are satisfied. z can be, for example, 0.0001 or greater, and preferably 0.0005 or greater.

The number average molecular weight of the polymer of formula (1) can be 100 to 8000000, and preferably 300 to 7000000, and more preferably 500 to 5000000. Note that the number average molecular weight is a value determined by gel permeation chromatography method.

The present invention 2 relates to the binder for a non-aqueous electricity storage element according to the present invention 1, where R¹ in formula (1) is a group represented by —(CH₂)ₘ—O—(CH₂)ₙ—CH₃,

where,

m is any integer of 0 to 3, and

n is any integer of 0 to 10.

The present invention 3 relates to the binder for a non-aqueous electricity storage element according to the present invention 1, where R¹ in formula (1) is a group represented by —(CH₂)ₘ—O—(CH₂)ₙ—(CH—(CH₂)ₕCH₃)—(CH₂)ₖ—CH₃,

where,

m is any integer of 0 to 3,

n is any integer of 0 to 10,

h is any integer of 0 to 10, and

k is any integer of 0 to 10.

The present invention 4 relates to the binder for a non-aqueous electricity storage element according to the present invention 1, where R¹ in formula (1) is a group represented by —(CH₂)ₙ—CH₃ (where n is any integer of 0 to 10).

The present invention 5 relates to the binder for a non-aqueous electricity storage element according to the present invention 1, where R¹ in formula (1) is —OR², and R² is a group represented by the following formula:

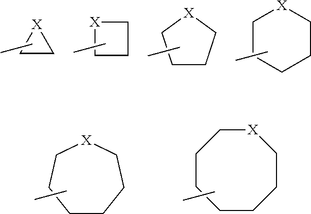

where, X is —CH₂—, —NH—, —O—, or —S—.

The present invention 6 relates to the binder for a non-aqueous electricity storage element according to the present invention 1, where R¹ in formula (1) is a group represented by —(CH₂)ₘ—S—(CH₂)ₙ—CH₃,

where,

m is any integer of 0 to 3, and

n is any integer of 0 to 10.

The present invention 7 relates to the binder for a non-aqueous electricity storage element according to any one of present inventions 1 to 6, the binder further including 1 to 10,000 ppm of at least one type selected from the group consisting of sodium, lithium, potassium, and ammonia.

The present invention 8 relates to an electrode for a non-aqueous electricity storage element including a coating layer formed by using the binder for a non-aqueous electricity storage element according to any one of the present inventions 1 to 7.

The present invention 9 relates to an electrode for a non-aqueous electricity storage element including an active material layer formed by using the binder for a non-aqueous electricity storage element according to any one of the present inventions 1 to 7.

The present invention 10 relates to a separator for a non-aqueous electricity storage element including a coating layer formed by using the binder for a non-aqueous electricity storage element according to any one of the present inventions 1 to 7.

The present invention 11 relates to a current collector for a non-aqueous electricity storage element including a coating layer formed by using the binder for a non-aqueous electricity storage element according to any one of the present inventions 1 to 7.

The present invention 12 relates to a non-aqueous electricity storage element including at least one of the electrode for a non-aqueous electricity storage element according to the present invention 8 or 9, the separator for a non-aqueous electricity storage element according to the present invention 10, or the current collector for a non-aqueous electricity storage element according to present invention 11.

The present invention 13 relates to the non-aqueous electricity storage element according to the present invention 12, where the non-aqueous electricity storage element is a non-aqueous secondary battery.

### Effect of the Invention

Using the binder for a non-aqueous electricity storage element of the present invention, a layer having a low water content and having excellent adhesion to substrates such as electrodes, separators, and current collectors can be formed. The binder of the present invention uses a combination in which the difference in the polarities of the hydrophilic group and the hydrophobic group is not extremely large, and a layer having a low water content can be formed by reducing the effect of enclosing water molecules to facilitate removal of water from the layer. By using at least one of electrode, separator, or current collector having this layer in a non-aqueous electricity storage element, short circuits between a positive electrode and a negative electrode due to melting of the separator or the like caused by accidental crushing of non-aqueous electricity storage element, by contamination of electric conductive foreign material, by thermal runaway, or the like can be prevented without deterioration of high-speed charge/discharge characteristics. Preferably, a layer having high heat resistance and high cation conductivity can be obtained by applying a composition containing the binder for a non-aqueous electricity storage element of the present invention, a filler, and a solvent to a substrate, such as an electrode, separator, or current collector, and by vaporizing the solvent.

When the composition described above is applied to a separator, the composition swells with polyethylene or polypropylene of components constituting the separator, and by removing the solvent via drying, adhesive properties can be enhanced.

### BRIEF DESCRIPTION OF THE DRAWINGS

FIG. 1 is a cross-sectional view of a battery electrode having a coating layer.

FIG. 2 is a cross-sectional view of a separator having a coating layer.

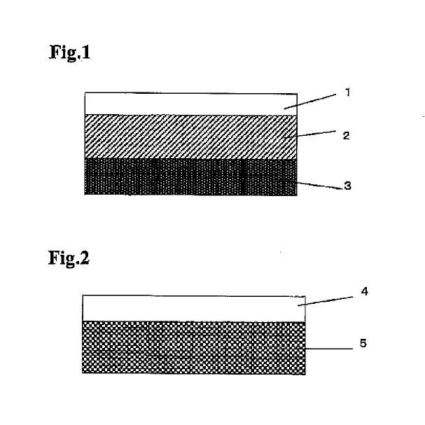

### MODE FOR CARRYING OUT THE INVENTION

### (A) Binder

The binder of the present invention contains a polymer represented by formula (1) above (also referred to as “binder containing a particular functional group”). The binder containing a particular functional group can be produced by mixing a polymerizable compound having a particular functional group and a radical initiator, and using any of the means of block polymerization, solution polymerization, suspension polymerization, or emulsion polymerization.

Binder Containing a Particular Functional Group

Examples of the particular functional group in the binder containing a particular functional group include an alkyl group that is unsubstituted or substituted with a halogen atom and/or a hydroxy group and that has 1 to 40 carbon atoms (—CH₂— in the alkyl group may be substituted with a group selected from an oxygen atom, sulfur atom, or cycloalkanediyl); or represents a group represented by —OR² (R² is a monovalent group of a 3 to 10 membered carbocyclic ring or heterocycle). A compound having the particular functional group described above and an unsaturated double bond can be used as a polymerizable compound having a particular functional group.

Specifically, the binder containing a particular functional group may be a polymer produced by mixing at least one type of polymerizable compound selected from the group consisting of A: a compound having any oxyalkyl group, B: a compound having any thioalkyl group, and C: a compound having any alkyl group; a radical initiator; and, as necessary, another polymerizable compound; and using any of the means of block polymerization, solution polymerization, suspension polymerization, or emulsion polymerization.

Examples of A: a compound having any oxyalkyl group include alkyl vinyl ether derivatives and alkyl allyl ether derivatives. Examples of B: a compound having any thioalkyl group include vinyl sulfide derivatives and allyl sulfide derivatives. Examples of C: a compound having any alkyl group include alkene derivatives and cycloalkane derivatives having an unsaturated double bond. These derivatives can form a polymer, in which unsaturated double bonds are addition-polymerized, by mixing each of these derivatives with a radical initiator to polymerize.

Alkyl vinyl ether derivative is not particularly limited, and examples thereof include ethyl vinyl ether, propyl vinyl ether, isopropyl vinyl ether, butyl vinyl ether, isobutyl vinyl ether, 2-methoxypropene, 2-chloroethyl vinyl ether, 2-ethylhexyl vinyl ether, cyclohexyl vinyl ether, 2,2,2-trifluoroethyl vinyl ether, triethyleneglycol divinyl ether, diethyleneglycol divinyl ether, 2-bromo tetrafluoroethyl trifluorovinyl ether, 4-(hydroxymethyl)cyclohexylmethyl vinyl ether, 2-(perfluoropropoxy)perfluoropropyl trifluoro vinyl ether, diethyleneglycol monovinyl ether, ethyleneglycol monovinyl ether, 2-(heptafluoropropoxy)hexafluoropropyl trifluorovinyl ether, octadecyl vinyl ether, perfluoropropoxyethylene, tetramethylene glycol monovinyl ether, 2-hydroxyethyl vinyl ether, 4-hydroxybutyl vinyl ether, cyclohexanedimethanol monovinyl ether, allyl vinyl ether, and the like. One type of these compounds may be used alone, or a combination of these compounds may be copolymerized.

The alkyl vinyl ether derivative may be copolymerized with vinyl acetate. In this case, poly(vinyl acetate/alkyl vinyl ether) can be produced by mixing vinyl acetate with an alkyl vinyl ether derivative at any proportion, and then copolymerizing the mixture using a radical initiator. In this copolymer, all or a part of units derived from vinyl acetate can be converted to a hydroxy group by performing hydrolysis in the presence of an acid or base. Note that, in the hydrolyzed copolymer, units derived from vinyl acetate may remain or may be absent.

The hydrolyzed copolymer may be used as is as the binder; however, the hydrolyzed copolymer may be used after removing ionic impurities, unreacted monomers, and the like by purification. The purification methods include an ion-exchange method using an ion-exchange resin, an ultrafiltration method, dialysis, and the like. One type of these methods may be used alone for the purification, or a combination of these methods may be used for the purification.

The alkyl allyl ether derivative is not particularly limited, and examples thereof include allyl methyl ether, allyl ethyl ether, allyl ether, acrolein dimethyl acetal, allyl butyl ether, 1,1,1-trimethylolpropane diallyl ether, 2H-hexafluoropropyl allyl ether, ethylene glycol monoallyl ether, glycerol α,α′-diallyl ether, allyl-n-octyl ether, allyl trifluoroacetate, 2,2-bis(allyloxymethyl)-1-butanol, and the like. One type of these compounds may be used alone, or a combination of these compounds may be copolymerized.

The alkyl allyl ether derivative may be copolymerized with vinyl acetate. In this case, poly(vinyl acetate/alkyl allyl ether) can be produced by mixing vinyl acetate with an alkyl allyl ether derivative at any proportion, and then copolymerizing the mixture using a radical initiator. In this copolymer, all or a part of units derived from vinyl acetate can be converted to a hydroxy group by performing hydrolysis in the presence of an acid or base. Note that, in the hydrolyzed copolymer, units derived from vinyl acetate may remain or may be absent.

The hydrolyzed copolymer may be used as is as the binder; however, the hydrolyzed copolymer may be used after removing ionic impurities, unreacted monomers, and the like by purification. The purification methods include an ion-exchange method using an ion-exchange resin, an ultrafiltration method, dialysis, and the like. One type of these methods may be used alone for the purification, or a combination of these methods may be used for the purification.

The vinyl (or allyl) sulfide derivative is not particularly limited, and examples thereof include ethyl vinyl sulfide, 1,1-bis(methylthio)ethylene, allyl methyl sulfide, allyl propyl sulfide, allyl sulfide, and the like. One type of these compounds may be used alone, or a combination of these compounds may be copolymerized.

The vinyl (or allyl) sulfide derivative may be copolymerized with vinyl acetate. In this case, poly(vinyl acetate/alkyl vinyl (or allyl) sulfide) can be produced by mixing vinyl acetate with a vinyl (or allyl) sulfide derivative at any proportion, and then copolymerizing the mixture using a radical initiator. In this copolymer, all or a part of units derived from vinyl acetate can be converted to a hydroxy group by performing hydrolysis in the presence of an acid or base. Note that, in the hydrolyzed copolymer, units derived from vinyl acetate may remain or may be absent.

The hydrolyzed copolymer may be used as is as the binder; however, ionic impurities, unreacted monomers, and the like can be removed by purification. The purification include an ion-exchange method using an ion-exchange resin, an ultrafiltration method, dialysis, and the like. One type of these methods may be used alone for the purification, or a combination of these methods may be used for the purification.

The alkene derivative is not particularly limited, and examples thereof include 1-butene, 1-pentene, 1-hexene, 1-heptene, 1-octene, 1-nonene, 1-decene, 1-undecene, 1-dodecene, 1-tridecene, 1-tetradecene, 1-pentadecene, and the like. One type of these compounds may be used alone, or a combination of these compounds may be copolymerized.

The alkene derivative may be copolymerized with vinyl acetate. In this case, poly(vinyl acetate/(cyclo) alkene) can be produced by mixing vinyl acetate with a (cyclo) alkene derivative at any proportion, and then copolymerizing the mixture using a radical initiator. In this copolymer, all or a part of units derived from vinyl acetate can be converted to a hydroxy group by performing hydrolysis in the presence of an acid or base. Note that, in the hydrolyzed copolymer, units derived from vinyl acetate may remain or may be absent.

The cycloalkane derivative having an unsaturated double bond is not particularly limited, and examples thereof include vinylcyclopentane, vinylcyclohexane, allylcyclohexane, methylenecyclopentane, methylenecyclohexane, pulegone, and the like. One type of these compounds may be used alone, or a combination of these compounds may be copolymerized.

The cycloalkane derivative having an unsaturated double bond may be copolymerized with vinyl acetate. In this case, poly(vinyl acetate/cycloalkane derivative having an unsaturated double bond) can be produced by mixing vinyl acetate with a cycloalkane derivative having an unsaturated double bond at any proportion, and then copolymerizing the mixture using a radical initiator. In this copolymer, all or a part of units derived from vinyl acetate can be converted to a hydroxy group by performing hydrolysis in the presence clan acid or base. Note that, in the hydrolyzed copolymer, units derived from vinyl acetate may remain or may be absent.

In the production of the binder containing a particular functional group, another polymerizable compound may be used, and specific examples thereof include compounds having an ethylenically unsaturated double bond (except for compounds of A to C). Specific examples include (meth)acrylic ester derivatives and (meth)acrylamide derivatives.

The (meth)acrylic ester derivative is not particularly limited, and examples thereof include methyl acrylate, ethyl acrylate, n-propyl acrylate, n-butyl acrylate, t-butyl acrylate, isobutyl acrylate, hexyl acrylate, allyl acrylate, 2-methoxyethyl acrylate, tetraethylene glycol diacrylate, methyl 3,3-dimethyl acrylate, 2-(2-ethoxyethoxy)ethyl acrylate, dipropylene glycol diacrylate, tripropylene glycol diacrylate, 2-hydroxyethyl acrylate, 2,2,2-trifluoroethyl acrylate, 1,4-bis(acryloyloxy)butane, neopentyl glycol diacrylate, isoamyl acrylate, methyl angelate, 1,6-bis(acryloyloxy)hexane, 1,5-bis(acryloyloxy)pentane, 2-cyanoethyl acrylate, ethyl 3-methyl crotonate, methyl tiglate, tetra(meth)acryloxyethane, methyl methacrylate, ethyl methacrylate, isobutyl methacrylate, isopropyl methacrylate, n-butyl methacrylate, t-butyl methacrylate, hexyl methacrylate, 2-ethylhexyl methacrylate, neopentyl glycol dimethacrylate, 2-ethoxyethyl methacrylate, diethylene glycol monomethyl ether methacrylate, and the like. One type of these compounds may be used alone, or a combination of these compounds may be copolymerized.

The (meth)acrylamide derivative is not particularly limited, and examples thereof include N-t-butylacrylamide, N-isopropylacrylamide, N,N-ethylacrylamide, N-t-butylmethacrylamide, N-[3-(dimethylamino)propyl]acrylamide, N-(3-dimethylaminopropyl)methacrylamide, N-dodecylacrylamide, N-(2-hydroxyethyl)acrylamide, diacetone acrylamide, 6-acrylamidohexanoic acid, 2-acrylamido-2-methylpropanesulfonic acid, 4-acryloylmorpholine, and the like. One type of these compounds may be used alone, or a combination of these compounds may be copolymerized.

In addition to those described above, vinyl crotonate, allyl methyl carbonate, allyl ethyl carbonate, 2-allyloxybenzaldehyde, 1,1,1-trimethylolpropane diallyl ether, 2,2-bis(4-allyloxy-3,5-dibromophenyl)propane, glycerol α,α-diallyl ether, allyl chloroformate, allyl chloroacetate, diallyl maleate, diallyl carbonate, allyl trifluoroacetate, 2-methyl-2-propenyl acetate, 2,2-bis(allyloxymethyl)-1-butanol, 3-buten-2-yl acetate, allyl methacrylate, allyl glycidyl ether, allyl cyanoacetate, phenyl vinyl sulfide, 4-methyl-5-vinylthiazole, allyl dimethyldithiocarbamate, allyl phenyl sulfide, S-allyl cysteine, allyl 1-pyrrolidinone carbodithioate, bis(4-methacryloylthiophenyl) sulfide, and the like can be used.

Another polymerizable compound, such as a (meth)acrylic ester derivative or (meth)acrylamide derivative, can be copolymerized, together with at least one type of polymerizable compound selected from the group consisting of A: a compound having any oxyalkyl group, B: a compound having any thioalkyl group, and C: a compound having any alkyl group, with vinyl acetate. In this case, when copolymerization with vinyl acetate is performed, a copolymer in which units derived from such another polymerizable compound are introduced can be produced by performing copolymerization using a radical initiator after mixing such another polymerizable compound and at least one type of polymerization compounds A to C with vinyl acetate at any proportion. The copolymer may be used as is as the binder; however, unreacted monomers and the like can be removed by purification. The purification include an ultrafiltration method, dialysis, and the like. One type of these methods may be used alone for the purification, or a combination of these methods may be used for the purification.

However, reaction conditions thereof are limited since, when a copolymer having units derived from a (meth)acrylic ester derivative and/or units derived from a (meth)acrylamide is hydrolyzed in the presence of an acid or base, hydrolysis of the units derived from (meth)acrylic ester and/or of the units derived from (meth)acrylamide may occur simultaneously with a reaction of converting units derived from vinyl acetate to hydroxy groups.

When copolymerization with vinyl acetate is performed, the molar ratio of at least one type of the polymerizable compounds A to C to the vinyl acetate is 0.001:9.999 to 9.999:0.001, and preferably 0.005:9.995 to 9.995:0.005.

Examples of the radical initiator include photo-radical initiators and thermal radical initiators. One type of these radical initiators may be used alone, or a plurality of these radical initiators may be combined for use.

The photo-radical initiator is not particularly limited, and examples thereof include acetophenone-based initiators, such as 4-phenoxydichloroacetophenone, 4-t-butyl-dichloroacetophenone, 4-t-butyl-trichloroacetophenone, diethoxyacetophenone, 2-hydroxy-2-methyl-1-phenylpropan-1-one, 1-(4-isopropylphenyl)-2-hydroxy-2-methylpropan-1-one, 1-(4-dodecylphenyl)-2-hydroxy-2-methylpropan-1-one, 4-(2-hydroxyethoxy)-phenyl(2-hydroxy-2-propyl)ketone, 1-hydroxycyclohexyl phenyl ketone, and 2-methyl-1-[4-(methylthio)phenyl]-2-morpholinopropane; benzoin-based initiators, such as benzoin, benzoin methyl ether, benzoin ethyl ether, benzoin isopropyl ether, benzoin isobutyl ether, and benzil dimethyl ketal; benzophenone-based initiators, such as benzophenone, benzoylbenzoic acid, methyl benzoylbenzoate, 4-phenylbenzophenone, hydroxybenzophenone, acrylated benzophenone, 4-benzoyl-4′-methyldiphenylsulfide, and 3,3′-dimethyl-4-methoxybenzopnehone; thioxanthone-based initiators, such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, and 2,4-diisopropylthioxanthone; 1-phenyl-1,2-propanedione-2(O-ethoxycarbonyl)oxime, 2,4,6-trimethylbenzoyldiphenylphosphine oxide, methylphenylglyoxylate, 9,10-phenanthrenequinone, camphorquinone, dibenzosuberone, 2-ethylanthraquinone, 4′,4″-diethylisophthalophenone, 3,3′,4,4′-tetra(t-butylperoxycarbonyl)benzophenone, 1-[4-(3-mercaptopropylthio)phenyl]-2-methyl-2-morpholin-4-yl-propan-1-one, 1-[4-(10-mercaptodecanylthio)phenyl]-2-methyl-2-morpholin-4-ylpropan-1-one, 1-(4-{2-[2-(2-mercapto-ethoxy)ethoxy]ethylthio}phenyl)-2-methyl-2-morpholin-4-ylpropan-1-one, 1-[3-(mercaptopropylthio)phenyl]-2-dimethylamino-2-benzylpropan-1-one, 1-[4-(3-mercaptopropylamino)phenyl]-2-dimethylamino-2-benzylpropan-1-one, 1-[4-(3-mercaptopropoxy)phenyl]-2-methyl-2-morpholin-4-yl-propan-1-one, bis(η5-2,4-cyclopentadien-1-yl)bis[2,6-difluoro-3-(1H-pyrrol-1-yl)phenyl]titanium, α-allyl benzoin, α-allyl benzoin aryl ether, 1,2-octanedione, 1-4-phenylthio-2-(O-benzoyloxime)]ethanone, 1-[9-ethyl-6-(2-methylbenzoyl)-9H-carbazol-3-yl]-1-(O-acetyloxime), bis(2,4,6-trimethylbenzoyl)-phenylphosphine oxide, 1,3-bis(p-dimethylaminobenzylidene)acetone, and the like.

Among the photo-radical initiators, an electron donor (hydrogen donor) can be added as an auxiliary initiator for intermolecular hydrogen abstraction type photo initiators, such as benzophenone, Michler's ketone, dibenzosuberone, 2-ethylanthraquinone, camphorquinone, and isobutylthioxanthone. As such an electron donor, aliphatic amine and aromatic amine having active hydrogen are exemplified. Specific examples of aliphatic amine include triethanolamine, methyl diethanolamine, and triisopropanolamine. Specific examples of aromatic amine include 4,4′-dimethylaminobenzophenone, 4,4′-diethylaminobenzophenone, ethyl 2-dimethylaminobenzoate, and ethyl 4-dimethylaminobenzoate.

The thermal radical initiator is not particularly limited, and examples thereof include azides, such as 4-azidoaniline hydrochloride and 4,4′-dithiobis(1-azidobenzene); disulfides, such as 4,4′-diethyl-1,2-dithiolane, tetramethylthiuram disulfide, and tetraethylthiuram disulfide; diacyl peroxides, such as octanoyl peroxide, 3,5,5-trimethylhexanoyl peroxide, decanoyl peroxide, lauroyl peroxide, succinic acid peroxide, benzoyl peroxide, 2,4-dichlorobenzoyl peroxide, and m-toluyl peroxide; peroxydicarbonates, such as di-n-propyl peroxydicarbonate, diisopropyl peroxydicarbonate, di-2-ethylhexyl peroxydicarbonate, and di-(2-ethoxyethyl) peroxydicarbonate; peroxyesters, such as t-butyl peroxyisobutyrate, t-butyl peroxypivalate, t-butyl peroxyoctanoate, octyl peroxyoctanoate, t-butylperoxy-3,5,5-trimethylhexanoate, t-butyl peroxyneododecanoate, octyl peroxyneododecanoate, t-butyl peroxylaurate, and t-butyl peroxybenzoate; dialkyl peroxides, such as di-t-butyl peroxide, t-butylcumyl peroxide, dicumyl peroxide, 2,5-dimethyl-2,5-di(t-butylperoxy) hexane, and 2,5-dimethyl-2,5-di(t-butyl)hexane; peroxyketals, such as 2,2-bis(t-butylperoxy)butane, 1,1-bis(t-butylperoxy)cyclohexane, 1,1-bis(t-butylperoxy)-3,3,5-trimethyloyclohexane, and N-butyl-4,4-bis(t-butylperoxy)valerate; ketone peroxides, such as methyl ethyl ketone peroxide; peroxides, such as p-menthane hydroperoxide and cumene hydroperoxide; azonitriles, such as 2,2′-azobis(4-methoxy-2,4-dimethylvaleronitrile), 2,2′-azobis(2,4-dimethylvaleronitrile), 2,2′-azobis(2-methylpropylnitrile), 2,2′-azobis(2-methylbutylnitrile), 1,1′-azobis(cyclohexane-1-carbonitrile), 1-[(1-cyano-1-methylethyl)azo]formamide, and 2-phenylazo-4-methoxy 2,4-dimethylvaleronitrile; azoamides, such as 2,2′-azobis(2-methyl-N-phenylpropionamidine)dihydrochloride, 2,2′-azobis[N-(4-chlorophenyl)-2-methylpropionamidine]dihydrochloride, 2,2′-azobis[N-(4-hydroxyphenyl)-2-methylpropionamidine]dihydrochloride, 2,2′-azobis[2-methyl-N-(4-phenylmethyl)propionamidine]dihydrochloride, 2,2′-azobis[2-methyl-N-(2-propenyl)propionamidine]dihydrochloride, 2,2′-azobis(2-methylpropionamidine)dihydrochloride, 2,2′-azobis[N-(2-hydroxyethyl)-2-methylpropionamidine]dihydrochloride, 2,2′-azobis[2-(5-methyl-2-imidazolin-2-yl)propane]dihydrochloride, 2,2′-azobis{2-[1-(2-hydroxyethyl)-2-imidazolin-2-yl]propane}dihydrochloride, and 2,2′-azobis[2-(2-imidazolin-2-yl)propane]; alkyl azo compounds, such as 2,2′-azobis(2,4,4-trimethylpentane) and 2,2′-azobis(2-methylpropane); as well as other azo compounds, such as dimethyl-2,2′-azobis(2-methylpropionate), 2,2′-azobis(4-cyanovaleric acid), and 2,2′-azobis[2-(hydroxymethyl)propionate]; bipyridine; initiators having a transition metal (e.g. copper(I) chloride and copper(II) chloride); and halogen compounds, such as methyl 2-bromopropionate, ethyl 2-bromopropionate, and ethyl 2-bromoisobutyrate.

A decomposition accelerator can be used together with the thermal radical generator. Examples of the decomposition accelerator include thiourea derivatives, organometallic complexes, amine compounds, phosphate compounds, toluidine derivatives, and aniline derivatives.

Examples of the thiourea derivative include N,N′-dimethylthiourea, tetramethylthiourea, N,N′-diethylthiourea, N,N′-dibutylthiourea, benzoylthiourea, acetylthiourea, ethylenethiourea, N,N′-diethylenethiourea, N,N′-diphenylthiourea, and N,N′-dilaurylthiourea. The thiourea derivative is preferably tetramethylthiourea or benzoylthiourea. Examples of the organometallic complex include cobalt naphthenate, vanadium naphthenate, copper naphthenate, iron naphthenate, manganese naphthenate, cobalt stearate, vanadium stearate, copper stearate, iron stearate, manganese stearate, and the like. Examples of the amine compound include primary to tertiary alkylamines or alkylenediamines, in which the number of carbons of the alkyl group or the alkylene group is represented by an integer of 1 to 18, diethanolamine, triethanolamine, dimethylbenzylamine, trisdimethylaminomethylphenol, trisdiethylaminomethylphenol, 1,8-diazabicyclo(5,4,0)-7-undecene, 1,8-diazabicyclo(5,4,0)-7-undecene,1,5-diazabicyclo(4,3,0)-nonene-5,6-dibutylamino-1,8-diazabicyclo(5,4,0)-7-undecene, 2-methylimidazole, 2-ethyl-4-methylimidazole, and the like. Examples of the phosphate compound include methacrylate phosphate, dimethacrylate phosphate, monoalkyl acid phosphate, dialkyl phosphate, trialkyl phosphate, dialkyl phosphite, trialkyl phosphite, and the like. Examples of the toluidine derivative include N,N-dimethyl-p-toluidine, N,N-diethyl-p-toluidine, and the like. Examples of the aniline derivative include N,N-dimethylaniline, N,N-diethylaniline, and the like.

The photo-radical initiator and/or the thermal radical generator is preferably used in the amount of 0.01 to 50 parts by mass, more preferably 0.1 to 20 parts by mass, and even more preferably 1 to 10 parts by mass, per 100 parts by mass of the polymerizable compound having a particular functional group. When the photo-radical initiator and the thermal radical generator are used in combination, the amount described above is a total content of the photo-radical initiator and the thermal radical generator. Furthermore, the amount of the electron donor is preferably 10 to 500 parts by mass per 100 parts by mass of the photo-radical initiator. The amount of the decomposition accelerator is preferably 1 to 500 parts by mass per 100 parts by mass of the thermal radical generator.

The binder containing a particular functional group can be produced by mixing at least one type of polymerizable compound selected from the group consisting of A: a compound having any oxyalkyl group, B: a compound having any thioalkyl group, and C: a compound having any alkyl group; a radical initiator; and, as necessary, another polymerizable compound; and using any of the means of block polymerization, solution polymerization, suspension polymerization, or emulsion polymerization.

Liquid Binder in which Solid Polymer Material is Dissolved in Solvent

In the present invention, a liquid binder in which a solid polymer material is dissolved in a solvent can be used in combination with a binder containing a particular functional group. The solvent can be appropriately selected from solvents capable of dissolving solid polymer materials, and two or more types of such solvents can be mixed and used.

The liquid binder in which a solid polymer material is dissolved in a solvent may be a solution or suspension.

As the solid polymer material, various publicly known binders may be used. Specific examples thereof include completely saponified polyvinyl alcohols (Kuraray Poval PVA-124, manufactured by Kuraray Co., Ltd.; JC-25, manufactured by Japan Vam & Poval Co., Ltd.; and the like), partially saponified polyvinyl alcohols (Kuraray Poval PVA-235, manufactured by Kuraray Co., Ltd.; JP-33, manufactured by Japan Vam & Poval Co., Ltd.; and the like), modified polyvinyl alcohols (Kuraray K polymer KL-118, Kuraray C polymer CM-318, Kuraray R polymer R-1130, and Kuraray LM polymer LM-10HD, manufactured by Kuraray Co., Ltd.; D polymer DF-20, anion-modified PVA AF-17, and alkyl-modified PVA ZF-15, manufactured by Japan Vam & Poval Co., Ltd.), carboxymethyl cellulose (H-CMC, DN-100L, 1120, and 2200, manufactured by Daicel Corporation; MAC200HC, manufactured by Nippon Paper Chemicals Co., Ltd.; and the like), hydroxyethyl cellulose (SP-400, manufactured by Daicel Corporation; and the like), polyacrylamide (Accofloc A-102, manufactured by MT Aqua Polymer, Inc.), polyoxyethylene (Alkox E-300, manufactured by Meisel Chemical Works, Ltd.), epoxy resins (EX-614, manufactured by Nagase ChemteX Corporation; Epikote 5003-W55, available from Japan Chemtech Ltd.; and the like), polyethyleneimine (Epomin P-1000, manufactured by Nippon Shokubai Co., Ltd.), polyacrylate (Accofloc C-502, manufactured by MT Aqua Polymer, Inc.; and the like), saccharides and derivatives thereof (Chitosan 5, manufactured by Wako Pure Chemical Industries, Ltd.; esterified starch Amycol, manufactured by Nippon Starch Chemical Co., Ltd.; Cluster Dextrin, manufactured by Glico Nutrition Co., Ltd.), polystyrene sulfonic acid (Poly-NaSS PS-100, manufactured by Tosoh Organic Chemical Co., Ltd.; and the like), and the like. These water-soluble polymers can be used in a state dissolved in water.

Examples of the solid polymer material also include emulsions, such as an acrylate polymer emulsion (Polysol F-361, F-417, S-65, and SH-502, manufactured by Showa Denko K.K.) and an ethylene-vinyl acetate copolymer emulsion (Paraflex OM-4000NT, OM-4200NT, OM-28NT, and OM-5010NT, manufactured by Kuraray Co., Ltd.), and these can be used in a state suspended in water. Furthermore, examples of the solid polymer material also include polymers, such as polyvinylidene fluoride (Kureha KF polymer #1120, manufactured by Kureha Corporation), modified polyvinyl alcohol (Cyanoresin CR-V, manufactured by Shin-Etsu Chemical Co., Ltd.), and modified pullulan (Cyanoresin CR-S, manufactured by Shin-Etsu Chemical Co., Ltd.), and these can be used in a state dissolved in N-methylpyrrolidone.

As the liquid binder in which a solid polymer material is dissolved in a solvent, a liquid binder in which a water-soluble polymer is dissolved in water and a binder in which an emulsion is suspended in water are preferable.

The liquid binder in which a solid polymer material is dissolved in a solvent can be solidified by heating and/or reducing pressure to remove the solvent. Such a binder also can form a gel electrolyte layer by impregnating a layer with an electrolytic solution, and thus ionic conductivity of the layer can be enhanced.

The proportion of a binder containing a particular functional group in the binder of the present invention is preferably 0.01 to 99.99% by mass, and more preferably 0.1 to 99.9% by mass, per 100% by mass of the binder. The binder containing a particular functional group may be used alone. Note that, for the liquid binder in which a solid polymer material is dissolved in a solvent, the proportion is based on the amount of the solid polymer material.

The binder of the present invention may be combined with a solvent, fillers, an active material, a core-shell foaming agent, a salt, a liquid having ionicity, a coupling agent, a stabilizing agent, a preservative, a surfactant, and the like to form a composition, and the composition may be applied to a substrate, such as an electrode, separator, and current collector of a non-aqueous electricity storage element.

(B) Solvent

The composition may contain a solvent in addition to the binder of the present invention. The solvent include a solvent contained in the liquid binder in which a solid polymer material is dissolved in a solvent as well as a solvent as a medium in the case where inorganic fillers are in the form of sol or the like.

The solvent can be compounded at any proportion to perform viscosity adjustment or the like, depending on the coating device. The solvent is not particularly limited, and examples thereof include liquids, such as hydrocarbons (propane, n-butane, n-pentane, isohexane, cyclohexane, n-octane, isooctane, benzene, toluene, xylene, ethylbenzene, amylbenzene, turpentine, pinene, and the like), halogen-based hydrocarbons (methyl chloride, chloroform, carbon tetrachloride, ethylene chloride, methyl bromide, ethyl bromide, chlorobenzene, chlorobromomethane, bromobenzene, fluorodichloromethane, dichlorodifluoromethane, difluorochloroethane, and the like), alcohols (methanol, ethanol, 1-propanol, isopropanol, 1-butanol, 1-pentanol, isoamyl alcohol, 1-hexanol, 1-heptanol, 1-octanol, 2-octanol, 1-dodecanol, nonanol, cyclohexanol, glycidol, and the like), ethers (diethyl ether, dichlorodiethyl ether, diisopropyl ether, dibutyl ether, diisoamyl ether, methylphenyl ether, and ethylbenzyl ether), furans (tetrahydrofuran, furfural, 2-methylfuran, cineol, methylal), ketones (acetone, methyl ethyl ketone, methyl-N-propyl ketone, methyl-N-amyl ketone, diisobutyl ketone, phorone, isophorone, cyclohexanone, acetophenone, and the like), esters (methyl formate, ethyl formate, propyl formate, methyl acetate, ethyl acetate, propyl acetate, n-amyl acetate, cyclohexaneacetic acid methyl ester, methyl butyrate, ethyl butyrate, propyl butyrate, butyl stearate, propylene carbonate, diethyl carbonate, ethylene carbonate, vinylene carbonate, and the like), polyhydric alcohols and derivatives thereof (ethylene glycol, ethylene glycol monomethyl ether, ethylene glycol monomethyl ether acetate, ethylene glycol monoethyl ether, methoxymethoxy ethanol, ethylene glycol monoacetate, diethylene glycol, diethylene glycol monomethyl ether, propylene glycol, propylene glycol monoethyl ether, 2-(2-butoxyethoxy)ethanol, and the like), aliphatic acids and phenols (formic acid, acetic acid, acetic anhydride, propionic acid, propionic anhydride, butyric acid, isovaleric acid, phenol, cresol, o-cresol, xylenol, and the like), nitrogen compounds (nitromethane, nitroethane, 1-nitropropane, nitrobenzene, monomethylamine, dimethylamine, trimethylamine, monoethylamine, diamylamine, aniline, monomethylaniline, o-toluidine, o-chloroaniline, cyclohexylamine, dicyclohexylamine, monoethanolamine, formamide, N,N-dimethylformamide, acetamide, acetonitrile, pyridine, α-picoline, 2,4-lutidine, quinoline, morpholine, and the like), sulfur, phosphorus, and other compounds (carbon disulfide, dimethyl sulfoxide, 4,4-diethyl-1,2-dithiolane, dimethyl sulfide, dimethyl disulfide, methanethiol, propanesultone, triethyl phosphate, triphenyl phosphate, diethyl carbonate, ethylene carbonate, amyl borate, and the like), inorganic solvents (liquid ammonia, silicone oil, and the like), and water.

From the perspective of coatability, the amount of the solvent is preferably an amount that results in a viscosity of 1 to 10,000 mPa·s. The viscosity is more preferably 2 to 5,000 mPa·s, and even more preferably 3 to 1,000 mPa·s. The type and content of the solvent, which adjusts the viscosity to be within such a range, can be appropriately selected. In the present invention, viscosity is a value measured at 25° C. using a cone-plate type rotational viscometer (number of rotation: 50 rpm).

(C) Fillers

The composition may contain fillers in addition to the binder of the present invention. One type of the fillers may be used alone, or a plurality of the fillers may be used in combination.

In particular, when the composition is used to form a heat resistant coating layer, fillers are preferably contained in the composition since a coating layer, which is a porous membrane, is formed. In this case, inorganic fillers are preferable from the perspective of heat resistance. The amount of the binder added in the composition is preferably an amount that does not fill up spaces formed among fillers and that is practically sufficient. In this case, the amount of the binder is preferably 0.01 to 49 parts by mass, more preferably 0.05 to 30 parts by mass, and even more preferably 0.1 to 20 parts by mass, per 100 parts by mass of the fillers.

Furthermore, when the composition is used for surface treatment of a current collector, electric conductive fillers, such as carbon-based fillers, are preferably contained in the composition. In this case, the amount of the binder is preferably 0.1 to 100 parts by mass, more preferably 0.5 to 80 parts by mass, and even more preferably 1 to 70 parts by mass, per 100 parts by mass of the fillers.

As the inorganic fillers, alumina can be used. Examples of methods of producing alumina include a method of hydrolyzing aluminum alkoxide that was dissolved in a solvent, a method of pyrolyzing a salt such as aluminum nitrate and then pulverizing, and the like. However, the method of producing alumina in the present invention is not particularly limited, and alumina produced by any method can be used. One type of alumina may be used alone, or a plurality of types of alumina may be used in combination.

Other inorganic fillers are not particularly limited, and examples thereof include powder of metal oxides, such as silica, zirconia, beryllia, magnesium oxide, titania, and iron oxide; clay minerals, such as sols, including colloidal silica, a titania sol, an alumina sal, and the like, talc, kaolinite, and smectite; carbides, such as silicon carbide and titanium carbide; nitrides, such as silicon nitride, aluminum nitride, and titanium nitride; borides, such as boron nitride, titanium boride, and boron oxide; composite oxides, such as mullite; hydroxides, such as aluminum hydroxide, magnesium hydroxide, and iron hydroxide; and barium titanate, strontium carbonate, magnesium silicate, lithium silicate, sodium silicate, potassium silicate, and glass; and the like.

These inorganic fillers may be used in the form of powder, in the form of a water-dispersed colloid, such as a silica sol or an aluminum sol, or in the state of being dispersed in an organic solvent, such as an organosol.

The particle size of the inorganic fillers is preferably in the range of 0.001 to 100 μm, and more preferably in the range of 0.005 to 10 μm. The average particle size is preferably in the range of 0.005 to 50 μm, and more preferably in the range of 0.01 to 8 μm. The average particle size and particle size distribution can be measured by, for example, a laser diffraction/scattering particle size distribution measuring device, and specifically, LA-920 manufactured by Horiba, Ltd. or the like can be used.

The inorganic fillers preferably contain alumina. Preferably, 50% by mass or greater of the inorganic fillers is preferably alumina, and 100% by mass of the inorganic fillers may be alumina. When alumina is used together with other inorganic fillers, the amount of the other inorganic fillers may be 0.1 to 49.9% by mass, and is preferably 0.5 to 49.5% by mass, and is more preferably 1 to 49% by mass, per 100% by mass of the entire inorganic components including alumina and the other inorganic fillers.

Examples of the organic fillers include particles, fibers, flakes, and the like of cellulose and/or polymers, which are three-dimensionally crosslinked and do not substantially undergo plastic deformation, selected from among polymers such as acrylic resins, epoxy resins, and polyimides. One type of the organic fillers may be used alone, or a plurality of the organic fillers may be used in combination.

The fillers may be electric conductive or may be electric non-conductive. When the composition is used for surface treatment of a current collector, electric conductive fillers are preferable. When the composition is used to form a heat resistant coating layer, electric conductive fillers may be added to the extent that does not impair the insulating properties.

Examples of the electric conductive fillers include metal fillers of Ag, Cu,

Au, Al, Mg, Rh, W, Mo, Co, Ni, Pt, Pd, Cr, Ta, Pb, V, Zr, Ti, In, Fe, Zn, or the like (forms thereof are not limited, and examples thereof include spherical, flake-like particles, colloid, and the like); Sn—Pb-based, Sn—In-based, Sn—Bi-based, Sn—Ag-based, Sn—Zn-based alloy fillers or the like (spherical particles, flake-like particles); carbon-based fillers, such as carbon blacks, such as acetylene black, furnace black, and channel black, graphite, graphite fibers, graphite fibrils, carbon fibers, activated carbon, charcoal, carbon nanotubes, and fullerene; metal oxide fillers, which exhibit electric conductivity by forming excess electrons due to the presence of lattice defect, selected from among zinc oxide, tin oxide, indium oxide, titanium oxide (titanium dioxide, titanium monoxide, and the like), and the like. The surface of the electric conductive fillers may be treated with a coupling agent or the like.

The size of the electric conductive fillers is preferably in the range of 0.001 to 100 μm, and more preferably in the range of 0.01 to 10 μm, from the perspectives of electric conductivity and liquid property. Electric conductive fillers having a size greater than the range described above can be also used to enhance adhesion to the active material layer utilizing anchoring effect by providing recesses and protrusions on the electric conductive coating layer that is formed by the composition containing the electric conductive fillers. In this case, large particles having electric conductivity can be blended at an amount of 1 to 50% by weight, and more preferably 5 to 10% by weight, relative to the amount of the electric conductive fillers having a size within the range described above. Examples of these electric conductive fillers include carbon fibers (Rahima R-A101, manufactured by Teijin Limited; fiber diameter: 8 μm, fiber length 30 μm) and the like. The average particle size of the electric conductive fillers is preferably in the range of 0.005 to 50 μm, and more preferably in the range of 0.01 to 8 p.m.

For the composition of the heat resistant coating layer, inorganic fillers are preferably used, and when other fillers are used in combination with inorganic fillers, such other fillers may be contained at an amount of 50 parts by mass or less, preferably 30 parts by mass or less, more preferably 20 parts by mass or less, and even more preferably 10 parts by mass or less, per 100 parts by mass of the inorganic fillers. Electric conductive fillers are preferably used for the composition for current collector treatment.

(D) Other Components

The composition may contain an active material, core-shell foaming agent, salt, liquid having ionicity, coupling agent, stabilizing agent, preservative, surfactant, and the like to the extent that does not impair the object of the present invention.

Active Material

Furthermore, when the composition is used to form an active material layer of an electrode of a non-aqueous electricity storage element, the composition preferably contain a binder and an active material. In this case, the amount of the binder is preferably 0.01 to 500 parts by mass, more preferably OA to 200 parts by mass, and even more preferably 0.5 to 100 parts by mass, per 100 parts by mass of the active material.

The active material can be appropriately selected depending on a non-aqueous electricity storage element that is desired. When the non-aqueous electricity storage element is a battery, examples thereof include an active material that donates and accepts alkali metal ions that control charging and discharging. For formation of a positive electrode active material layer of a lithium secondary battery, examples thereof include lithium salts (e.g., lithium cobalt oxide, olivine-type lithium iron phosphate, and the like). For formation of an electrode active material layer of an electric double-layer capacitor, examples thereof include activated carbon and the like. The form and amount of the active material can be appropriately selected depending on an active material layer that is desired. For example, when a particulate active material is used, the size thereof can be in the range of 0.001 to 100 μm, and preferably in the range of 0.005 to 10 μm. The average particle size is preferably in the range of 0.005 to 50 pin, and more preferably in the range of 0.01 to 8 μm.

Core-Shell Foaming Agent

The composition may contain a core-shell foaming agent. Examples of the foaming agent include EXPANCEL (manufactured by Japan Fillite Co., Ltd.) and the like. Typically, core-shell foaming agents exhibit poor long-term reliability against electrolytic solutions since the shell thereof is an organic substance, and therefore, a material, in which the foaming agent is further coated with an inorganic substance, can be used. Examples of such an inorganic substance include metal oxides, such as alumina, silica, zirconia, beryllia, magnesium oxide, titania, and iron oxide; sols, such as colloidal silica, a titania sol, and an alumina sol; gels, such as silica gel and activated alumina; composite oxides, such as mullite; hydroxides, such as aluminum hydroxide, magnesium hydroxide, and iron hydroxide; metals, such as barium titanate, gold, silver, copper, nickel, and the like.

By using a core-shell foaming agent in which a shell that softens at a specific temperature and a core formed from a material whose volume expands by vaporization due to heating or the like are combined, shutdown function can be achieved by allowing the foaming agent to foam, so that the distance between electrodes are increased when thermal runaway is caused in a battery. Furthermore, the distance between electrodes can be increased by expanding the shell portion, and thus short circuits or the like can be prevented. Furthermore, since the expanded shell portion maintains its shape even after the heat generation stops, secondary short circuit that is caused by narrowing the distance between electrodes can be prevented. Furthermore, by coating the core-shell foaming agent with an inorganic substance, effect of electrolysis during charging and discharging can be reduced, and also the active hydrogen group on the surface of the inorganic substance serves as a counterion in the ionic conductivity, making it possible to efficiently enhance the ionic conductivity.

The composition may contain 1 to 99 parts by mass, and preferably 10 to 98 parts by mass, of the core-shell foaming agent per 100 parts by mass of the binder. When the core-shell foaming agent and the inorganic fillers are used in combination, the core-shell foaming agent may be contained at 99 parts by mass or less, preferably 1 to 99 parts by mass, more preferably 10 to 98 parts by mass, and even more preferably 20 to 97 parts by mass, per 100 parts by mass total of the inorganic fillers and the binder.

Salt

The composition may contain salts which serve as sources for various ions. By this, ionic conductivity can be enhanced. Also, electrolyte used for batteries can be added, In the case of lithium ion batteries, examples of the electrolyte include lithium hydroxide, lithium silicate, lithium hexafluorophosphate, lithium tetrafluoroborate, lithium perchlorate, lithium bis(trifluoromethanesulfonyl)imide, lithium bis(pentafluoroethanesulfonyl)imide, lithium trifluoromethanesulfonate, and the like. In the case of sodium ion batteries, examples of the electrolyte include sodium hydroxide, sodium perchlorate, and the like. In the case of calcium ion batteries, examples of the electrolyte include calcium hydroxide, calcium perchlorate, and the like. In the case of magnesium ion batteries, examples of the electrolyte include magnesium perchlorate and the like. In the case of electric double-layer capacitors, examples of the electrolyte include tetraethylammonium tetrafluoroborate, triethylmethylanunonium bis(trifluoromethanesulfonyl)imide, tetraethylammonium bis(trifluoromethanesulfonyl)imide, and the like.

The composition may contain the salt described above at 300 parts by mass or less, preferably 0.1 to 300 parts by mass, more preferably 0.5 to 200 parts by mass, and even more preferably 1 to 100 parts by mass, per 100 parts by mass total of the inorganic fillers and the binder. The salt described above may be added as powder or porous substance, or may be added after dissolving in a component to be compounded.

Liquid Having Ionicity

The compound may contain a liquid having ionicity. The liquid having ionicity may be a solution, in which the salt described above is dissolved in a solvent, or an ionic liquid. Examples of the solution, in which a salt is dissolved in a solvent, include solutions in which a salt, such as lithium hexafluorophosphate or tetraethylammonium tetrafluoroborate, is dissolved in a solvent, such as dimethyl carbonate.

Examples of the ionic liquid include imidazolium salt derivatives, such as 1,3-dimethylimidazolium methyl sulfate, 1-ethyl-3-methylimidazolium bis(pentafluoroethylsulfonyl)imide, and 1-ethyl-3-methylimidazolium bromide; pyridinium salt derivatives, such as 3-methyl-1-propylpyridinium bis(trifluoromethylsulfonyl)imide and 1-butyl-3-methylpyridinium bis(trifluoromethylsulfonyl)imide; alkylammonium derivatives, such as tetrabutylammonium heptadecafiuorooctanesulfonate and tetraphenylammonium methanesulfonate; phosphonium salt derivatives, such as tetrabutylphosphonium methanesulfonate; conductivity imparting composite agents such as composites of polyalkylene glycol and lithium perchlorate; and the like.

The composition may contain 0.01 to 40 parts by mass, and preferably 0.1 to 40 parts by mass, of the liquid having ionicity per 100 parts by mass of the binder. When the liquid having ionicity and the inorganic fillers are used in combination, the liquid having ionicity may be contained at 40 parts by mass or less, preferably 0.01 to 40 parts by mass, more preferably 0.1 to 30 parts by mass, and even more preferably 0.5 to 5 parts by mass, per 100 parts by mass of the inorganic fillers.

Coupling Agent

The composition may contain a coupling agent. Examples of silane coupling agents include fluorine-based silane coupling agents, such as (tridecafluoro-1,1,2,2-tetrahydrooctyl)triethoxysilane; bromine-based silane coupling agents, such as (2-bromo-2-methyl)propionyloxypropyltriethoxysilane; oxetane-modified silane coupling agents, such as a coupling agent manufactured by Toagosei Co., Ltd. (trade name: TESOX); and silane coupling agents, such as vinyltrimethoxysilane, vinyltriethoxysilane, γ-chloropropyltrimethoxysilane, γ-aminopropyltriethoxysilane, N-(β-aminoethyl)-γ-aminopropyltrimethoxysilane, N-(β-aminoethyl)-γ-aminopropylmethyldimethoxysilane, γ-glycidoxypropyltrimethoxysilane (commercially available as KBM-403 (manufactured by Shin-Etsu Chemical Co., Ltd.)), β-glycidoxypropylmethyldimethoxysilane, γ-methacryloyloxypropyltrimethoxysilane, γ-methacryloyloxypropylmethyldimethoxysilane, γ-mercaptopropyltrimethoxysilane, and cyanohydrin silyl ether. Substances which is formed by hydrolyzing these silane coupling agents in advance and has —SiOH may be also used.

Examples of the titanium coupling agent include triethanolamine titanate, titanium acetylacetonate, titanium ethylacetoacetate, titanium lactate, titanium lactate ammonium salt, tetrastearyl titanate, isopropyltricumylphenyl titanate, isopropyltri(N-aminoethyl-aminoethyl)titanate, dicumylphenyloxyacetate titanate, isopropyltrioctanoyl titanate, isopropyldimethacrylisostearoyl titanate, titanium lactate ethyl ester, octylene glycol titanate, isopropyltriisostearoyl titanate, triisostearylisopropyl titanate, isopropyltridodecylbenzenesulfonyl titanate, tetra(2-ethylhexyl)titanate, butyl titanate dimer, isopropylisostearoyldiacryl titanate, isopropyl tri(dioctylphosphate) titanate, isopropyl tris(dioctylpyrophosphate) titanate, tetraisopropyl bis(dioctylphosphite) titanate, tetraoctyl bis(ditridecylphosphite) titanate, tetra(2,2-diallyloxymethyl-1-butyl)bis(di-tridecyl)phosphite titanate, bis(dioctylpyrophosphate)oxyacetate titanate, bis(dioctylpyrophosphate)ethylene titanate, tetra-i-propyl titanate, tetra-n-butyl titanate, and diisostearoylethylene titanate, and the like.

As the coupling agent, titanium-based coupling agents, vinyltrimethoxysilane, vinyltriethoxysilane, γ-chloropropyltrimethoxysilane, γ-aminopropyltriethoxysilane, N-(β-aminoethyl)-γ-aminopropyltrimethoxysilane, N-(β-aminoethyl)-γ-aminopropylmethyldimethoxysilane, γ-glycidoxypropyltrirnethoxyglane, β-glycidoxypropylmethyldimethoxysilane, γ-methacryloyloxypropyltrimethoxysilane, γ-methacryloyloxypropylmethyldimethoxysilane, γ-mercaptopropyltrimethoxysilane, and cyanohydrin silyl ether are preferable. One type of the silane coupling agent or titanium coupling agent can be used, or a combination of two or more types of the silane coupling agent or titanium coupling agent can be used.

The coupling agents described above interacts with a battery electrode surface or a separator surface, thereby making it possible to enhance adhesion. Furthermore, ion conductivity can be enhanced by covering the surface of the fillers with the coupling agent since a repellent effect of the coupling agent molecules forms spaces between the fillers, so that ions conduct through the spaces. Furthermore, defoaming property can be further enhanced by covering the surface of the fillers, such as inorganic fillers, silicone particles, or polyolefin particles, with the coupling agent, thereby making the fillers hydrophobic. Furthermore, the water content, which leads to reduction in non-aqueous electricity storage element characteristics, can be reduced since the amount of water absorbed on the surface can be reduced by substituting the active hydrogen on the surface of the fillers with the silane coupling agent.

The composition may contain 0.01 to 500 parts by mass, and preferably 0.1 to 100 parts by mass, of the coupling agent per 100 parts by mass of the binder.

Stabilizing Agent

The composition may contain a stabilizing agent. The stabilizing agent is not particularly limited, and examples thereof include phenolic antioxidants, such as 2,6-di-t-butylphenol, 2,4-di-t-butylphenol, 2,6-di-t-butyl-4-ethylphenol, and 2,4-bis-(N-octylthio)-6-(4-hydroxy-3,5-di-t-butylanilino)-1,3,5-triazine; aromatic amine antioxidants, such as alkyldiphenylamine, N,N′-diphenyl-p-phenylenediamine, 6-ethoxy-2,2,4-trimethyl-1,2-dihydroquinoline, and N-phenyl-N′-isopropyl-p-phenylenediamine; sulfide hydroperoxide decomposers, such as dilauryl-3,3′-thiodipropionate, ditridecyl-3,3′-thiodipropionate, bis[2-methyl-4-{3-N-alkylthiopropionyloxy}-5-t-butylphenyl]sulfide, and 2-mercapto-5-methylbenzimidazole; phosphorus hydroperoxide decomposers, such as tris(isodecyl)phosphite, phenyldiisooctyl phosphite, diphenylisooctyl phosphite, di(nonylphenyl)pentaerythritol diphosphite, 3,5-di-t-butyl-4-hydroxybenzyl phosphate diethyl ester, and sodium bis(4-t-butylphenyl)phosphate; salicylate light stabilizing agents, such as phenyl salicylate and 4-t-octylphenyl salicylate; benzophenone light stabilizing agents, such as 2,4-dihydroxybenzophenone and 2-hydroxy-4-methoxybenzophenone-5-sulfonic acid; benzotriazole light stabilizing agents, such as 2-(2′-hydroxy-5′-methylphenyl)benzotriazole and 2,2′-methylenebis[4-(1,1,3,3-tetramethylbutyl)-6-(2N-benzotriazol-2-yl)phenol]; hindered amine light stabilizing agents, such as phenyl-4-piperidinyl carbonate and bis-[2,2,6,6-tetramethyl-4-piperidinyl]sebacate; Ni light stabilizing agents, such as [2,2′-thio-bis(4-t-octylphenolato)]-2-ethylhexylamine-nickel(II); cyanoacrylate light stabilizing agents; oxalic anilide light stabilizing agents; fullerene light stabilizing agents, such as fullerene, hydrogenated fullerene, and fullerene hydroxide; and the like. One type of these stabilizing agents may be used alone, or a plurality of these stabilizing agents may be combined for use.

The composition may contain 0.01 to 10 parts by mass, and preferably 0.05 to 5 parts by mass, of the stabilizing agent per 100 parts by mass of the binder. When the stabilizing agent and the inorganic fillers are used in combination, the stabilizing agent may be contained at 10 parts by mass or less, preferably 0.01 to 10 parts by mass, more preferably 0.05 to 5 parts by mass, and even more preferably 0.1 to 1 part by mass, per 100 parts by mass of the inorganic fillers.

Preservative

The composition may contain a preservative. By this, storage stability of the composition can be adjusted.

Examples of the preservative include acids, such as benzoic acid, salicylic acid, dehydroacetic acid, and sorbic acid; salts, such as sodium benzoate, sodium salicylate, sodium dehydroacetate, and potassium sorbate; isothiazoline preservatives, such as 2-methyl-4-isothiazolin-3-one and 1,2-benzoisothiazolin-3-one; alcohols, such as methanol, ethanol, isopropyl alcohol, and ethylene glycol; para-hydroxybenzoates, phenoxyethanol, benzalkonium chloride, chlorhexidine hydrochloride, and the like.

One type of these preservatives may be used alone, or a plurality of these preservatives may be combined for use.

The composition may contain 0.0001 to 1 part by mass of the preservative per 100 parts by mass of the binder. When the preservative and the inorganic fillers are used in combination, the preservative may be contained at 1 part by mass or less, preferably 0.0001 to 1 part by mass, and more preferably 0.0005 to 0.5 parts by mass, per 100 parts by mass of the inorganic fillers.

Surfactant

The composition may contain a surfactant to adjust the wettability and defoaming property of the composition. Furthermore, the composition may contain an ionic surfactant to enhance the ionic conductivity.

As the surfactant, any of anionic surfactant, amphoteric surfactant, nonionic surfactant can be used.

Examples of the anionic surfactant include a soap, lauryl sulfate, polyoxyethylene alkyl ether sulfate, alkylbenzenesulfonate (e.g., dodecylbenzenesulfonate), polyoxyethylene alkyl ether phosphate, polyoxyethylene alkyl phenyl ether phosphate, N-acylamino acid salt, α-olefinsulfonate, alkyl sulfate, alkyl phenyl ether sulfate, methyltaurine salt, trifluoromethanesulfonate, pentafluoroethanesulfonate, heptafluoropropanesulfonate, nonafluorobutanesulfonate, and the like. As counter cations, sodium ions, lithium ions, or the like can be used. In a lithium-ion battery, a lithium ion type surfactant is more preferable, and, in a sodium-ion battery, a sodium ion type surfactant is more preferable.

Examples of the amphoteric surfactant include alkyldiaminoethylglycine hydrochloride, 2-alkyl-N-carboxymethyl-N-hydroxyethylimidazolinium betaine, betaine lauryldimethylaminoacetate, coconut oil fatty acid amide propyl betaine, fatty acid alkyl betaine, sulfobetaine, amine oxide, and the like.

Examples of the nonionic surfactant include alkyl ester compounds of polyethylene glycol, alkyl ether compounds, such as triethylene glycol monobutyl ether, ester compounds, such as polyoxysorbitan ester, alkylphenol compounds, compounds having an acetylene skeleton, fluorine compounds, silicone compounds, and the like.

One type of these surfactants may be used alone, or a plurality of these surfactants may be combined for use.

The composition may contain 0.01 to 50 parts by mass, and preferably 0.05 to 20 parts by mass, of the surfactant per 100 parts by mass of the binder. When the surfactant is used in combination with the inorganic fillers, the surfactant may be contained at 50 parts by mass or less, preferably 0.01 to 50 parts by mass, more preferably 0.05 to 20 parts by mass, and even more preferably 0.1 to 10 parts by mass, per 100 parts by mass of the inorganic fillers.

The composition is for non-aqueous electricity storage element, and specifically, the composition can be used for protecting electrodes or separators. A coating layer can be formed at least on the surface of an electrode or separator using the composition of the present invention; however, a part of the coating layer may be incorporated into the electrode or separator.

Production Method of Composition

The composition can be produced by mixing and stirring the components described above, and the following three compositions will be described as examples.

(1) Composition for forming a heat resistant coating layer (composition for a heat resistant coating layer)

(2) Composition for forming an active material (composition for an active material layer)

(3) Composition for surface treatment of a current collector (composition for current collector surface treatment)

(1) The composition for a heat resistant coating layer can be used to form a Layer having heat resistance on a separator, electrode, or current collector. In particular, battery safety can be enhanced by enhancing insulating properties which is achieved by forming, on the separator or the electrode surface, a coating layer that is electrically insulating but has ionic conductivity. The composition for a heat resistant coating layer may further contain organic fillers and/or inorganic fillers having excellent heat resistance, and in the case where, for example, alumina is used as the inorganic fillers, the alumina may be blended in a state dispersed in a solvent. Specific examples include a composition containing inorganic fillers, the binder of the present invention, and a solvent. The preferable amounts of these components are as described above.

(2) The composition for an active material layer can be used to form an active material layer of an electrode of a non-aqueous electricity storage element. For the composition for an active material layer, an active material can be appropriately selected and compounded depending on a non-aqueous electricity storage element that is desired. When the non-aqueous electricity storage element is a battery, examples thereof include an active material that donates and accepts alkali metal ions that control charging and discharging of the battery, For example, lithium salt particles, such as lithium cobalt oxide and olivine-type lithium iron phosphate, can be used for the positive electrode. Graphite, silicon alloy particles, and the like can be used for the negative electrode. Furthermore, carbon-based fillers described above can be also used to enhance electric conductivity. Specific examples include a composition containing an active material, the binder of the present invention, and a solvent. The preferable amounts of these components are as described above.

(3) The composition for current collector surface treatment can be used to reduce resistance to enhance resistance against electrolysis by coating the composition on the current collector surface. As a result, enhancement of the non-aqueous electricity storage element characteristics and elongation of the life can be achieved. The composition for current collector surface treatment may contain electric conductive fillers, represented by carbon-based fillers, as an electric conductive auxiliary. Specific examples include a composition containing electric conductive fillers (e.g., carbon-based fillers), the binder of the present invention, and a solvent. The preferable amounts of these components are as described above.

When these compositions are stirred, stirring devices, such as a propeller mixer, planetary mixer, hybrid mixer, kneader, emulsifying homogenizer, ultrasonic homogenizer, and the like can be used for the stirring. Furthermore, the stirring can be performed while heating or cooling as necessary. Note that use of the binder of the present invention is not limited to these examples, and the binder can be applied to parts that are used as parts in contact with an electrolytic solution. In the case of laminate film-type batteries, the binder of the present invention can be also used for an adhesive property enhancing agent, sealing agent, adhesion enhancing agent for tabs, and the like.

Forming Method of Each Composition Layer Using the Composition

The composition is for a non-aqueous electricity storage element and, specifically, can form a layer by coating on the surface of an electrode, separator, or current collector of a non-aqueous electricity storage element and vaporizing the solvent. The layer formed as described above has excellent adhesion to the substrate and has low water content. Furthermore, the composition can form a layer having excellent resistance against electrolytic solution and/or excellent heat resistance, and by forming the layer, the composition can protect the surface of an electrode or separator.

The present invention includes various layers obtained by using the composition of the present invention. That is, the method of forming various layers using the composition of the present invention includes, in the case where the binder is dissolved in a solvent, a step of forming at least one layer of composition layer of the composition on the surface of an electrode, separator, or current collector, and a step of vaporizing the solvent. Furthermore, in the case where the binder is a solid that is insoluble to a solvent, the method includes a step of forming at least one layer of composition layer of the composition on the surface of an electrode, separator, or current collector, a step of vaporizing the solvent, and a step of heat-fusing a solid binder when the solid binder does not undergo heat-fusion in a temperature conditions for the vaporization of the solvent.

Forming Method of Composition Layer

The formation of the composition layer on an electrode, separator, or current collector can be performed by applying the composition on the surface using a gravure coater, slit die coater, spray coater, dipping, and the like.

(1) In the case of a composition for a heat resistant coating layer, the thickness of the applied composition is preferably in the range of 0.01 to 100 μm and, from the perspectives of electrical characteristics and adhesion, more preferably in the range of 0.05 to 50 μm. In the present invention, the thickness after the composition layer is dried, that is the thickness of the coating layer, is preferably in the range of 0.01 to 100 μm, and more preferably in the range of 0.05 to 50 μm. When the thickness of the coating layer is within the range described above, the insulating properties against electric conduction will be sufficient, and thus risks of short circuits can be sufficiently reduced. Furthermore, when the thickness of the coating layer is increased, the resistance is increased proportional to the thickness; however, within the range described above, reduction in charge/discharge characteristics of the non-aqueous electricity storage element due to excessively high resistance against ionic conductivity is likely to be avoided.

(2) In the case of a composition for an active material layer, the thickness of the layer may be changed depending on the design of the non-aqueous electricity storage element; however, the thickness of the applied composition is preferably in the range of 0.01 to 1000 μm and, from the perspectives of electrical characteristics and adhesion, more preferably in the range of 1 to 500 μm. In the present invention, the thickness after the composition layer is dried, that is the thickness of the active material layer, is preferably in the range of 2 to 300 μm, and more preferably in the range of 10 to 200 μm. When the thickness is within this range, reduction in battery capacity due to the thickness of the active material layer being too thin and reduction in charge/discharge characteristics of the non-aqueous electricity storage element due to excessively high resistance against ionic conductivity caused by too large thickness are likely to be avoided.

(3) In the case of a composition for current collector surface treatment, the thickness of the applied composition is preferably in the range of 0.01 to 100 μm and, from the perspectives of electrical characteristics and adhesion, more preferably in the range of 0.05 to 50 μm. In the present invention, the thickness after the coating and the following drying, that is the thickness of the surface treatment layer, is preferably in the range of 0.01 to 100 μm, and more preferably in the range of 0.05 to 50 μm. When the thickness is within this range, reduction in adhesion and tendency of peeling-off due to the thickness of the surface treatment layer being too thin and reduction in charge/discharge characteristics of the non-aqueous electricity storage element due to excessively high resistance against electric conductivity caused by too large thickness are likely to be avoided.

Vaporization Method of Solvent

When the composition contains a solvent, the solvent can be vaporized by being heated or being subjected to vacuum treatment during the formation of each layer. As the heating method, a hot-blast stove, infrared heater, heat roll, or the like can be used. The vacuum drying can be performed by introducing a composition layer of the composition in a chamber and evacuating the chamber. Furthermore, when a sublimable solvent is used, the solvent can be vaporized also by freeze-drying. The heating temperature and the heating time in the heating method are not particularly limited as long as the temperature and the time allow the solvent to vaporize, and for example, the heating temperature and the heating time can be set to 80 to 120° C. and 0.1 to 2 hours. By vaporizing the solvent, the components, except the solvent, of each composition adhere to the electrode, separator, and current collector, and thus can be heat-fused in the case where the binder is a hot-melt type binder. When the composition contains fillers, a porous membrane is formed as a result, and when the composition is a composition for a heat resistant coating layer, a heat resistant porous membrane is formed.

Heating Method

In the formation of each layer, when the binder is in the form of particles, the binder particles can be heat-fused to each other to solidify. In this case, solidification can be performed by heat-fusing the particles at a temperature at which the particles are completely melted, or solidification can be performed in a state, in which spaces exist between the particles adhering to one another at points, caused by being cooled in a state in which only the surfaces of the particles are thermally melted and the particles fuse and adhere to one another. In the former solidification by heat fusion, there are many portions included of a continuous phase, and ionic conductivity, mechanical strength, and heat resistance are high. In the latter solidification by heat fusion, there are a little portions included of a continuous phase, and thus the ionic conductivity through the fused organic particles, mechanical strength, and heat resistance are poor, but the spaces formed between the particles can be impregnated with an electrolytic solution to enhance the ionic conductivity. Furthermore, since a structure, in which spaces are randomly arranged, is formed in the latter case, when dendrite is generated, the structure inhibits the linear growth of dendrite, and enhances the effect of preventing short circuits. As a heating fusion method for the hot melt, various publicly known methods, such as a method using hot air, a hot plate, an oven, an infrared ray, or ultrasonic fusion, can be used, and the density of a protective agent layer can be enhanced by pressing while the heating is performed. Furthermore, as a cooling method, various publicly known methods, such as a method using cooling gas or a method of pressing against a radiator plate, can be used as well as air cooling. Furthermore, when heating is performed to the temperature at which the binder melts, heating can be performed for 0.1 to 1000 seconds at the temperature at which the binder melts.

By the forming methods including the steps described above, an electrode, separator, or current collector having a layer corresponding to each of the compositions can be obtained. That is, when the composition for a heat resistant coating layer is used, a heat resistant coating layer is formed. When the composition for an active material layer is used, an active material layer is formed. When the composition for current collector surface treatment is used, a surface treatment layer is formed. For the heat resistant coating layer and surface treatment layer, when the electrode, separator, or current collector is a porous body, at least a part of the layer may be incorporated therein. The porosity of these layers is 10% or greater, preferably 15 to 90%, and more preferably 20 to 80%. The porosity can be calculated using density measurement. Impregnation of the pores with the electrolytic solution enhances the charge/discharge characteristics of batteries, such as electricity storage elements. When the current collector is a porous body, the heat resistant coating layer and/or the surface treatment layer are preferably a porous body, by which ionic conductivity can be enhanced by increasing the surface area per unit area of the current collector. Such a current collector can be suitably applied for an electric double-layer capacitor.

Electrode and/or Separator and/or Current Collector

The present invention relates to an electrode, separator, or current collector having the layer described above. The non-aqueous electricity storage element in which the electrode, separator, or current collector is provided, is not particularly limited, and examples thereof include various publicly known batteries (which may be primary batteries or secondary batteries; e.g., lithium ion batteries, sodium ion batteries, calcium ion batteries, magnesium ion batteries, and the like) and capacitors (electric double-layer capacitor and the like). Therefore, the electrode is not particularly limited, and examples thereof include positive electrodes or negative electrodes of various publicly known batteries and capacitors. A coating layer can be formed by coating or impregnating at least one surface of these with the composition and then vaporizing the solvent. The composition can be applied on at least one of a positive electrode or a negative electrode, or on both of the positive electrode and the negative electrode. Examples of the separator include porous materials made of polypropylene or polyethylene, nonwoven fabric made of cellulose, polypropylene, polyethylene, or polyester and the like. The coating layer can be formed by coating or impregnating both sides or one side of the separator with the composition and then vaporizing the solvent. The coating layer of the present invention can be used in a state, in which the coating layer is adhered closely to a separator or electrode that faces the coating layer, and it is possible to perform drying after the separator and the electrode are adhered closely before the solvent is vaporized, or it is possible to adhere these parts closely by performing hot-pressing after the battery is assembled.

Battery

The present invention relates to non-aqueous electricity storage elements including an electrode and/or separator and/or current collector having a coating layer, formed by using a composition containing the binder of the present invention, on the surface thereof. Furthermore, the present invention relates to non-aqueous electricity storage elements including an electrode having an active material layer formed by using a composition containing the binder of the present invention. The non-aqueous electricity storage element can be produced by a publicly known method. Furthermore, ionic conductivity can be imparted to the non-aqueous electricity storage element by impregnating the coating layer with an electrolytic solution, or the coating layer itself may have ionic conductivity and may be assembled into a battery as a solid electrolyte membrane.

### EXAMPLES

The present invention will be explained specifically using examples below; however, the present invention is not limited to these. Unless otherwise noted, “part” and “%” refer to “part by mass” and “% by mass”, respectively.

### Production of Polymer

### Example 1

### Production of Oxyalkyl Group-Containing Polymer Using Butyl Vinyl Ether as Starting Material

A 500 mL glass three-necked flask equipped with a stirrer, a thermometer, and a reflux condenser was prepared, and in the three-necked flask, 10 parts by mass of vinyl acetate (manufactured by Kanto Chemical Co., Inc.) and 1 part by mass of butyl vinyl ether (manufactured by Tokyo Chemical Industry Co., Ltd.) as monomers of a copolymer, 0.01 parts by mass of AIBN (reagent name: 2,2′-azobis(isobutyronitrile), manufactured by Wako Pure Chemical Industries, Ltd.) as a thermal radical initiator, and 1.3 mL of methanol as a solvent were placed and stirred at the room temperature for 10 minutes to mix uniformly. Thereafter, the mixture was heated and stirred at 70° C. for 2 hours. The progress of the reaction was checked by tracking vinyl groups (1400 cm⁻¹) using FT-IR. After completion of the reaction, the reaction product was cooled and then dissolved by adding 100 mL of methanol thereto to obtain a methanol solution of a poly(vinyl acetate/butyl vinyl ether) copolymer. This solution was used as is for the following reaction.

Hydrolysis of Oxyalkyl Group-Containing Polymer Obtained by Using Butyl Vinyl Ether as Starting Material

A 500 mL three-necked flask equipped with a stirrer and a nitrogen balloon was prepared, and the methanol solution of a poly(vinyl acetate/butyl vinyl ether) copolymer was placed in the flask. A nitrogen gas having purity of 99.99% was blown into the three-necked flask for 30 minutes to fill the system in the three-necked flask with a nitrogen atmosphere. To the flask, 10 parts by mass of a 28% sodium methoxide methanol solution (manufactured by Wako Pure Chemical Industries, Ltd.) was added and stirred at the room temperature for 12 hours. The progress of the reaction was checked by tracking acetyl groups (1730 cm⁻¹) using FT-IR. After completion of the reaction, 100 mL of ion-exchanged water was added and stirred uniformly.

Thereafter, 30 mL of ion-exchange resin (product name: SK-1BH, manufactured by Mitsubishi Plastics, Inc.) and 60 mL of ion-exchange resin (product name: SA-10AOH, manufactured by Mitsubishi Plastics, Inc.) that were sufficiently washed with ion-exchanged water in advance were added and stirred at the room temperature for 2 hours.

Thereafter, the ion-exchange resins were removed using a nylon mesh (product name: nylon mesh 200, manufactured by Tokyo Screen Co., Ltd.), and the filtrate was transferred to a 500 mL eggplant-shaped flask. The methanol and the ion-exchanged water, which were the solvents, were distilled off under reduced pressure using a rotary evaporator to obtain a poly(vinyl alcohol/butyl vinyl ether) copolymer which was the target product. The ratio of the number of the vinyl alcohol units to the number of the butyl vinyl ether units in the copolymer was 10:1, and the number average molecular weight was 50000.

### Example 2

### Production of Oxyalkyl Group-Containing Polymer Using Butyl Allyl Ether as Starting Material

A 500 mL glass three-necked flask equipped with a stirrer, a thermometer, and a reflux condenser was prepared, and in the three-necked flask, 10 parts by mass of vinyl acetate (manufactured by Kanto Chemical Co., Inc.) and 1 part by mass of butyl allyl ether (manufactured by Tokyo Chemical Industry Co., Ltd.) as monomers of a copolymer, 0.01 parts by mass of AIBN (reagent name: 2,2′-azobis(isobutyronitrile), manufactured by Wako Pure Chemical Industries, Ltd.) as a thermal radical initiator, and 1.3 mL, of methanol as a solvent were placed and stirred at the room temperature for 10 minutes to mix uniformly. Thereafter, the mixture was heated and stirred at 70° C. for 2 hours. The progress of the reaction was checked by tracking allyl groups (1400 cm⁻¹) using FT-IR. After completion of the reaction, the reaction product was cooled and then dissolved by adding 100 mL of methanol thereto to obtain a methanol solution of a poly(vinyl acetate/butyl allyl ether) copolymer. This solution was used as is for the following reaction.

Hydrolysis of Oxyalkyl Group-Containing Polymer Obtained by Using Butyl Allyl Ether as Starting Material

A poly(vinyl alcohol/butyl allyl ether) copolymer which was the target product was obtained by performing a reaction in the same manner as in the hydrolysis of the polymer obtained by using butyl vinyl ether as a starting material of Example 1. The ratio of the vinyl alcohol units to the butyl allyl ether units in the copolymer was 10:1, and the number average molecular weight was 50000.

### Example 3

### Production of Oxyalkyl Group-Containing Polymer Using 2-Ethylhexyl Vinyl Ether as Starting Material

A 500 mL glass three-necked flask equipped with a stirrer, a thermometer, and a reflux condenser was prepared, and in the three-necked flask, 10 parts by mass of vinyl acetate (manufactured by Kanto Chemical Co., Inc.) and 1 part by mass of 2-ethylhexyl vinyl ether (manufactured by Tokyo Chemical Industry Co., Ltd.) as monomers of a copolymer, 0.01 parts by mass of AIBN (reagent name: 2,2′-azobis(isobutyronitrile), manufactured by Wako Pure Chemical Industries, Ltd.) as a thermal radical initiator, and 1.3 mL of methanol as a solvent were placed and stirred at the room temperature for 10 minutes to mix uniformly. Thereafter, the mixture was heated and stirred at 70° C. for 2 hours. The progress of the reaction was checked by tracking vinyl groups (1400 cm⁻¹) using FT-IR. After completion of the reaction, the reaction product was cooled and then dissolved by adding 100 mL of methanol thereto to obtain a methanol solution of a poly(vinyl acetate/2-ethylhexyl vinyl ether) copolymer. This solution was used as is for the following reaction.

Hydrolysis of Oxyalkyl Group-Containing Polymer Obtained by Using 2-Ethylhexyl Vinyl Ether as Starting Material

A poly(vinyl alcohol/2-ethylhexyl vinyl ether) copolymer which was the target product was obtained by performing a reaction in the same manner as in the hydrolysis of the polymer obtained by using butyl vinyl ether as a starting material of Example 1. The ratio of the vinyl alcohol units to the 2-ethylhexyl vinyl ether units in the copolymer was 10:1, and the number average molecular weight was 40000.

### Example 4

### Production of Alkyl Group-Containing Polymer Using 1-Hexene as Starting Material

A 500 mL glass three-necked flask equipped with a stirrer, a thermometer, and a reflux condenser was prepared, and in the three-necked flask, 10 parts by mass of vinyl acetate (manufactured by Kanto Chemical Co., Inc.) and 1 part by mass of 1-hexene (manufactured by Tokyo Chemical Industry Co., Ltd.) as monomers of a copolymer, 0.01 parts by mass of AIBN (reagent name: 2,2′-azobis(isobutyronitrile), manufactured by Wako Pure Chemical Industries, Ltd.) as a thermal radical initiator, and 1.3 mL of methanol as a solvent were placed and stirred at the room temperature for 10 minutes to mix uniformly. Thereafter, the mixture was heated and stirred at 70° C. for 2 hours. The progress of the reaction was checked by tracking alkene groups (1400 cm⁻¹) using FT-IR. After completion of the reaction, the reaction product was cooled and then dissolved by adding 100 mL of methanol thereto to obtain a methanol solution of a poly(vinyl acetate/hexene) copolymer. This solution was used as is for the following reaction.

Hydrolysis of Alkyl Group-Containing Polymer Obtained by Using 1-Hexene as Starting Material

A poly(vinyl alcohol/hexene) copolymer which was the target product was obtained by performing a reaction in the same manner as in the hydrolysis of the polymer obtained by using butyl vinyl ether as a starting material of Example 1. The ratio of the vinyl alcohol units to the hexene units in the copolymer was 10:1, and the number average molecular weight was 40000.

### Example 5

### Production of Oxyalkyl Group-Containing Polymer Using Cyclohexyl Vinyl Ether as Starting Material

A 500 mL glass three-necked flask equipped with a stirrer, a thermometer, and a reflux condenser was prepared, and in the three-necked flask, 10 parts by mass of vinyl acetate (manufactured by Kanto Chemical Co., Inc.) and 1 part by mass of cyclohexyl vinyl ether (manufactured by Tokyo Chemical Industry Co., Ltd.) as monomers of a copolymer, 0.01 parts by mass of AIBN (reagent name: 2,2′-azobis(isobutyronitrile), manufactured by Wako Pure Chemical Industries, Ltd.) as a thermal radical initiator, and 1.3 mL of methanol as a solvent were placed and stirred at the room temperature for 10 minutes to mix uniformly. Thereafter, the mixture was heated and stirred at 70° C. for 2 hours. The progress of the reaction was checked by tracking vinyl groups (1400 cm⁻¹) using FT-IR. After completion of the reaction, the reaction product was cooled and then dissolved by adding 100 mL of methanol thereto to obtain a methanol solution of a poly(vinyl acetate/cyclohexyl vinyl ether) copolymer. This solution was used as is for the following reaction.

Hydrolysis of Oxyalkyl Group-Containing Polymer Obtained by Using Cyclohexyl Vinyl Ether as Starting Material

A polyvinyl alcohol/cyclohexyl vinyl ether) copolymer which was the target product was obtained by performing a reaction in the same manner as in the hydrolysis of the polymer obtained by using butyl vinyl ether as a starting material of Example 1. The ratio of the vinyl alcohol units to the cyclohexyl vinyl ether units in the copolymer was 10:1, and the number average molecular weight was 40000.

### Example 6

### Production of Thioalkyl Group-Containing Polymer Using Ethyl Vinyl Sulfide as Starting Material

A 500 mL glass three-necked flask equipped with a stirrer, a thermometer, and a reflux condenser was prepared, and in the three-necked flask, 10 parts by mass of vinyl acetate (manufactured by Kanto Chemical Co., Inc.) and 1 part by mass of ethyl vinyl sulfide (manufactured by Tokyo Chemical Industry Co., Ltd.) as monomers of a copolymer, 0.01 parts by mass of AIBN (reagent name: 2,2′-azobis(isobutyronitrile), manufactured by Wako Pure Chemical Industries, Ltd.) as a thermal radical initiator, and 1.3 mL of methanol as a solvent were placed and stirred at the room temperature for 10 minutes to mix uniformly. Thereafter, the mixture was heated and stirred at 70° C. for 2 hours. The progress of the reaction was checked by tracking vinyl groups (1400 cm′) using FT-IR. After completion of the reaction, the reaction product was cooled and then dissolved by adding 100 mL of methanol thereto to obtain a methanol solution of a poly(vinyl acetate/ethyl vinyl sulfide) copolymer. This solution was used as is for the following reaction.

Hydrolysis of Thioalkyl Group-Containing Polymer Obtained by Using Ethyl Vinyl Sulfide as Starting Material

A poly(vinyl alcohol/ethyl vinyl sulfide) copolymer which was the target product was obtained by performing a reaction in the same manner as in the hydrolysis of the polymer obtained by using butyl vinyl ether as a starting material of Example 1. The ratio of the vinyl alcohol units to the ethyl vinyl sulfide units in the copolymer was 10:1, and the number average molecular weight was 50000.

### Reference Example 7

### Production of Polymer Using n-Butyl Acrylate as Starting Material

A 500 mL glass three-necked flask equipped with a stirrer, a thermometer, and a reflux condenser was prepared, and in the three-necked flask, 10 parts by mass of vinyl acetate (manufactured by Kanto Chemical Co., Inc.) and 1 part by mass of n-butyl acrylate (manufactured by Tokyo Chemical Industry Co., Ltd.) as monomers of a copolymer, 0.01 parts by mass of AIBN (reagent name: 2,2′-azobis(isobutyronitrile), manufactured by Wako Pure Chemical Industries, Ltd.) as a thermal radical initiator, and 1.3 mL of methanol as a solvent were placed and stirred at the room temperature for 10 minutes to mix uniformly. Thereafter, the mixture was heated and stirred at 70° C. for 2 hours. The progress of the reaction was checked by tracking vinyl groups (1400 cm⁻¹) using FT-IR. After completion of the reaction, the reaction product was cooled and then dissolved by adding 100 mL of methanol thereto to obtain a methanol solution of a poly(vinyl acetate/n-butyl acrylate) copolymer. This solution was used as is for the following reaction.

Hydrolysis of Polymer Obtained by Using n-Butyl Acrylate as Starting Material

Although a reaction was performed in the same manner as in the hydrolysis of the polymer obtained by the solution polymerization of Example 1, poly(vinyl alcohol/n-butyl acrylate), which was the target, was not obtained since the acetyl groups of the vinyl acetate units were eliminated and the n-butyl groups of the n-butyl acrylate units were also eliminated.

### Reference Example 8

### Production of Polymer Using N-n-Butylacrylamide as Starting Material

A 500 mL glass three-necked flask equipped with a stirrer, a thermometer, and a reflux condenser was prepared, and in the three-necked flask, 1.0 parts by mass of vinyl acetate (manufactured by Kanto Chemical Co., Inc.) and 1 part by mass of N-n-butylacrylamide (manufactured by Tokyo Chemical Industry Co., Ltd.) as monomers of a copolymer, 0.01 parts by mass of AIBN (reagent name: 2,2′-azobis(isobutyronitile), manufactured by Wako Pure Chemical Industries, Ltd.) as a thermal radical initiator, and 1.3 mL of methanol as a solvent were placed and stirred at the room temperature for 10 minutes to mix uniformly. Thereafter, the mixture was heated and stirred at 70° C. for 2 hours. The progress of the reaction was checked by tracking vinyl groups (1400 cm⁻¹) using FT-IR. After completion of the reaction, the reaction product was cooled and then dissolved by adding 100 mL of methanol thereto to obtain a methanol solution of a poly(vinyl acetate/N-n-butylacrylamide) copolymer. This solution was used as is for the following reaction.

Hydrolysis of Polymer Obtained by Using N-n-Butylacrylamide as Starting Material

Although a reaction was performed in the same manner as in the hydrolysis of the polymer obtained by the solution polymerization of Example 1, poly(vinyl alcohol/n-butylacrylamide), which was the target, was not obtained since the acetyl groups of the vinyl acetate units were eliminated and a part of the n-butyl groups of the n-butylacrylamide units was also eliminated.

### Comparative Example 1

### Production of Polymer Using Vinyl Acetate as Starting Material

A 500 mL glass three-necked flask equipped with a stirrer, a thermometer, and a reflux condenser was prepared, and in the three-necked flask, 11 parts by mass of vinyl acetate (manufactured by Kanto Chemical Co., Inc.), 0.01 parts by mass of AIBN (reagent name: 2,2′-azobis(isobutyronitrile), manufactured by Wake Pure Chemical Industries, Ltd.) as a thermal radical initiator, and 1.3 mL of methanol as a solvent were placed and stirred at the room temperature for 10 minutes to mix uniformly. Thereafter, the mixture was heated and stirred at 70° C. for 2 hours. The progress of the reaction was checked by tracking vinyl groups (1400 cu⁻¹) using FT-IR. After completion of the reaction, the reaction product was cooled and then dissolved by adding 100 mL of methanol thereto to obtain a methanol solution of polyvinyl acetate. This solution was used as is for the following reaction.

Hydrolysis of Polymer Obtained by Using Vinyl Acetate as Starting Material

Polyvinyl alcohol which was the target product was obtained by performing a reaction in the same manner as in the hydrolysis of the polymer obtained by using butyl vinyl ether as a starting material of Example 1.

Production of Composition for Heat Resistant Coating Layer

In Examples 9 to 14, Reference Examples 15 to 17, and Comparative Examples 2 and 3, methods of producing a composition for a heat resistant coating layer containing a polymer are described.

### Example 9

In a 100 L tank made of polypropylene, 10 L of ion-exchanged water and 10 kg of alumina particles were added and stirred for 12 hours to produce a 50% dispersion. The dispersion was filtered using a nylon mesh having a sieve opening of 20 μm, and water was added at an amount that compensated the water loss during the step, so that a dispersion containing 50% of alumina particles (average particle size: 0.5 μm) was produced.

To 50 kg of the dispersion, 20 kg of water was added. To the mixture, 200 g of the poly(vinyl alcohol/butyl vinyl ether) produced in Example 1 was added, stirred for 6 hours, and dissolved to obtain a composition 1. Note that, in the composition, the content of alumina in the components except the solvent was 96.1% by mass.

### Examples 10 to 14

As Examples 10 to 14, compositions 2 to 6 were obtained in the same manner as in Example 9 except for using 200 g of polymer shown in Table 1 in place of 200 g of the poly(vinyl alcohol/butyl vinyl ether). In all the compositions, the contents of alumina in the components except the solvent were 96.1% by mass.

### Reference Examples 15 and 16

Preparations of the compositions were attempted in the same manner as in Example 9 except for using 200 g of polymer shown in Table 1 in place of 200 g of the poly(vinyl alcohol/butyl vinyl ether); however, the polymers aggregated within the solution and partially formed a lump, and thus it was not possible to prepare the compositions.

### Reference Example 17

### Production of Alumina Slurry 9

A dispersion containing 50% of alumina particles (average particle size: 0.5 μm) was prepared in the same manner as in Example 9.

Compounding of Composition 9

To 50 kg of the dispersion, 20 kg of water was added. After 200 g of poly(vinyl alcohol/butyl acrylic acid) obtained in Reference Example 7 was added to the mixture and stirred for 6 hours, aggregation occurred and a lump was partially formed, and thus it was not possible to prepare the composition.

### Comparative Example 2

As Comparative Example 2, a composition 10 was obtained in the same manner as in Example 9 except for using 200 g of polymer shown in Table 1 in place of 200 g of the poly(vinyl alcohol/butyl vinyl ether).

### Comparative Example 3

In a 100 L tank made of polypropylene, 10 L of N-methylpyrrolidone and 10 kg of alumina particles (average particle size: 0.5 μm) were added and stirred for 12 hours to produce a 50% dispersion. The dispersion was filtered using a nylon mesh having a sieve opening of 20 μm, and N-methylpyrrolidone was added at an amount that compensated the loss during the step, so that a dispersion containing 50% of alumina particles was produced.

To 50 kg of the dispersion, 20 kg of N-methylpyrrolidone was added. To the mixture, 200 g of polyvinylidene fluoride (manufactured by Kureha Corporation) was added, stirred for 6 hours, and dissolved to obtain a composition 11 as Comparative Example 3. Note that, in the composition, the content of alumina in the components except the solvent was 96.1% by mass.

TABLE 1

| | Name of | | |
|---|---|---|---|
| | composition | Polymer Example | Name of polymer |
| Example 9 | Composition 1 | Example 1 | Poly(vinyl alcohol/butyl vinyl ether) |
| Example 10 | Composition 2 | Example 2 | Poly(vinyl alcohol/butyl allyl ether) |
| Example 11 | Composition 3 | Example 3 | Poly(vinyl alcohol/(2-ethylhexyl vinyl ether)) |
| Example 12 | Composition 4 | Example 4 | Poly(vinyl alcohol/hexene) |
| Example 13 | Composition 5 | Example 5 | Poly(vinyl alcohol/cyclohexyl vinyl ether) |
| Example 14 | Composition 6 | Example 6 | Poly(vinyl alcohol/ethyl vinyl sulfide) |
| Reference | Composition 7 | Reference | Poly(vinyl acetate/n-butyl acrylate) |
| Example 15 | | Example 7* | |
| Reference | Composition 8 | Reference | Poly(vinyl acetate/n-butylacrylamide) |
| Example 16 | | Example 8** | |
| Reference | Composition 9 | Reference | Poly(vinyl alcohol/n-butyl acrylic acid) |
| Example 17 | | Example 7*** | |
| Comparative | Composition 10 | Comparative | Polyvinyl alcohol |
| Example 2 | | Example 1 | |
| Comparative | Composition 11 | — | Polyvinylidene fluoride |
| Example 3 | | | |

*Polymer before undergoing the hydrolysis of Reference Example 7
**Polymer before undergoing the hydrolysis of Reference Example 8
***Polymer after undergoing the hydrolysis of Reference Example 7

Methods of producing a lithium ion secondary battery using compositions 1 to 6, 10, and 11 will be described below.

Production of Lithium Secondary Battery (Coating Layer Formed on Negative Electrode)

Examples 18 to 23 and Comparative Examples 4 and 5 are lithium ion secondary batteries using a negative electrode, on which a coating layer was formed using the composition, a positive electrode, and a separator.

### Example 18

### Production of Positive Electrode

In a 10 L planetary mixer equipped with a cooling jacket, 520 parts of a 15% NMP solution of polyvinylidene fluoride (PVdF) (Kureha KF Polymer #1120, manufactured by Kureha Corporation), 1140 parts of lithium cobalt oxide (abbreviated as “LCO”) (CELLSEED C-5H, manufactured by Nippon Chemical Industrial Co., Ltd.), 120 parts of acetylene black (DENKA BLACK HS-100, manufactured by Denki Kagaku Kogyo Kabushiki Kaisha), and 5400 parts of NMP were added, and the mixture was stirred while being cooled so that the temperature of the liquid did not exceed 30° C. until the mixture became uniform (active material layer. composition 1). This composition was applied to a rolled aluminum current collector (manufactured by Nippon Foil Mfg. Co., Ltd.; width: 300 mm; thickness: 20 μm) so that the applied composition had a width of 180 mm and a thickness of 200 μm, and dried in a hot-air oven at 130° C. for 30 seconds. The resultant current collector was roll-pressed at a linear load of 530 kgf/cm. The thickness of the positive electrode active material layer after the pressing was 22

Production of Negative Electrode

In a 10 L planetary mixer equipped with a cooling jacket, 530 parts of a 15% NMP solution of PVdF (Kureha KF Polymer #9130, manufactured by Kureha Corporation), 1180 parts of graphite (GR-15, manufactured by Nippon Graphite Industries, Ltd.), and 4100 parts of NMP were added, and the mixture was stirred while being cooled so that the temperature of the liquid did not exceed 30° C. until the mixture became uniform. This composition was applied to a rolled copper foil current collector (manufactured by Nippon Foil Mfg. Co., Ltd.; width: 300 mm; thickness: 20 μm) so that the applied composition had a width of 180 mm and a thickness of 200 μm, and dried in a hot-air oven at 100° C. for 2 minutes. The resultant current collector was roll-pressed at a linear load of 360 kgf/cm. The thickness of the negative electrode active material layer after the pressing was 28 μm.

Production of Negative Electrode Having Coating Layer

The negative electrode was coated with the composition 1 using a gravure coater in a manner so that the dry thickness was 5 μm, and heated at 100° C. for 60 seconds to produce a negative electrode having a coating layer in which the battery electrode or microporous membrane separator coating layer had a thickness of 5 μm.

Production of Lithium Ion Secondary Battery

Each of the positive electrode and the negative electrode having the coating layer was cut into 40 mm×50 mm so that a 10 mm width region having no active material layer in both ends was included at the short side, and an aluminum tab and a nickel tab were welded by resistance welding to the metal exposed portions of the positive electrode and the negative electrode, respectively. A microporous membrane separator (#2400, manufactured by Celgard, LLC.) was cut into a size having a width of 45 mm and a length of 120 mm, and folded in three and the positive electrode and negative electrode were disposed between the folded separator so that the positive electrode and negative electrode faced to each other, and the resultant material was disposed between an aluminum laminate cell folded in half having a width of 50 mm and a length of 100 mm, and a sealant was placed between the portions with which the tabs for the individual electrodes were in contact, and then the sealant portion and the sides perpendicular to the sealant portion were subjected to heat lamination to obtain the cell in a bag form. This cell was subjected to vacuum drying in a vacuum oven at 100° C. for 24 hours, and then vacuum-impregnated with a 1 M electrolytic solution containing lithium hexafluorophosphate/(EC:DEC=1:1, volume ratio) (LBG-96533, manufactured by Kishida Chemical Co., Ltd.) in a dry glove box, and then the excess electrolytic solution was withdrawn, followed by sealing using a vacuum sealer, to produce a lithium ion secondary battery.

### Examples 19 to 23 and Comparative Examples 4 and 5

As Examples 19 to 23 and Comparative Examples 4 and 5, lithium ion secondary batteries were produced in the same manner as in Example 18 except for using a composition shown in Table 2 in place of composition 1.

Production of Lithium Secondary Battery (Coating Layer Formed on Positive Electrode)

In Examples 24 to 29 and Comparative Examples 6 and 7, methods of producing a lithium ion secondary battery using a positive electrode, on which a coating layer was formed using the composition, a negative electrode, and a separator are described.

### Example 24

### Production of Negative Electrode

A negative electrode (having no coating layer) was produced using the method of Example 18.

Production of Positive Electrode Having Coating Layer

A positive electrode was produced by the method of Example 18, and then a positive electrode having a coating layer was produced by using the composition 1 by the same method as that formed the coating layer on the negative electrode in Example 18.

Production of Lithium Ion Secondary Battery

Lithium ion secondary batteries were produced in the same manner as in Example 18 except for using a positive electrode having a coating layer as the positive electrode and using a negative electrode having no coating layer as the negative electrode.

### Examples 25 to 29 and Comparative Examples 6 and 7

As Examples 25 to 29 and Comparative Examples 6 and 7, lithium ion secondary batteries were produced in the same manner as in Example 24 except for using a composition shown in Table 2 in place of composition 1.

Production of Lithium Secondary Battery (Coating Layer Formed on Separator)

In Examples 30 to 35 and Comparative Examples 8 and 9, methods of producing a lithium ion secondary battery using a separator, on which a coating layer was formed using the composition, a positive electrode, and a negative electrode are described.

### Example 30

### Production of Negative Electrode and Positive Electrode

A negative electrode (having no coating layer) and a positive electrode (having no coating layer) were produced using the method of Example 18.

Production of Separator Having Coating Layer

The microporous membrane separator (#2400, manufactured by Celgard, LLC.) was coated with the composition 1 using a gravure coater in a manner so that the dry thickness was 5 μm, and heated at 60° C. for 60 seconds to produce a separator having a coating layer in which the coating layer had a thickness of 2 μm.

Production of Lithium Ion Secondary Battery

Lithium ion secondary batteries were produced in the same manner as in Example 18 except for using a microporous membrane separator having a coating layer as the microporous membrane separator and using a negative electrode having no coating layer as the negative electrode.

### Examples 31 to 35 and Comparative Examples 8 and 9

As Examples 31 to 35 and Comparative Examples 8 and 9, lithium ion secondary batteries were produced in the same manner as in Example 30 except for using a composition shown in Table 2 in place of composition 1.

Production of Lithium Secondary Battery (Coating Layer Formed on Negative Electrode)/Example 36 and Comparative Example 10

Example 36 and Comparative Example 10 are lithium ion secondary batteries using a negative electrode, on which a coating layer was formed using the composition, a positive electrode, and a separator. As Example 36 and Comparative Example 10, lithium ion secondary batteries were produced in the same manner as in Example 18 except for using a composition shown in Table 2 and using a nonwoven fabric separator in place of the porous membrane separator.

Production of Lithium Secondary Battery (Coating Layer Formed on Positive Electrode)/Example 37 and Comparative Example 11 Example 37 and Comparative Example 11 are lithium ion secondary batteries using a positive electrode, on which a coating layer was formed using the composition, a negative electrode, and a separator. As Example 37 and Comparative Example 11, lithium ion secondary batteries were produced in the same manner as in Example 24 except for using a composition shown in Table 2 and using a nonwoven fabric separator in place of the porous membrane separator.

Production of Lithium Secondary Battery (Coating Layer Formed on Separator)/Example 38 and Comparative Example 12

Example 38 and Comparative Example 12 are lithium ion secondary batteries using a separator, on which a coating layer was formed using the composition, a positive electrode, and a negative electrode. As Example 38 and Comparative Example 12, lithium ion secondary batteries were produced in the same manner as in Example 30 except for using a composition shown in Table 2 and using a nonwoven fabric separator in place of the porous membrane separator.

### Comparative Example 13

As Comparative Example 13, a lithium ion secondary battery was produced in the same manner as in Example 18 except for using a negative electrode having no coating layer as the negative electrode. Comparative Example 13 is an example of lithium ion secondary battery which did not use the composition and in which the positive electrode, the negative electrode, and the microporous membrane separator did not have any coating layers.

### Comparative Example 14

As Comparative Example 14, a lithium ion secondary battery was produced in the same manner as in Comparative Example 13 except for using a nonwoven fabric separator in place of a microporous membrane separator as the separator. Comparative Example 14 is an example of lithium ion secondary battery which did not use the composition and in which the positive electrode, the negative electrode, and the nonwoven fabric separator did not have any coating layers.

### Production of Lithium Secondary Battery (Positive Electrode Active Material Layer was Formed Using Binder)/Example 39

### Example 39

This is an example of a lithium ion secondary battery produced in the same manner as in Comparative Example 13 except for producing an active material layer composition 2 using 78 parts of the poly(vinyl alcohol/butyl vinyl ether) copolymer of Example 1 in place of 520 parts of a 15% NMP solution of PVdF (Kureha KF polymer #1120, manufactured by Kureha Corporation) which was the binder of the positive electrode active material.

### Production of Lithium Secondary Battery (Current Collector Surface was Treated Using Binder)/Example 40 and Comparative Example 15

### Example 40

In a 10 L tank made of polypropylene, 1 L of ion-exchanged water was placed, and 50 g of poly(vinyl alcohol/butyl vinyl ether) copolymer of Example 1 was added while being stirred, and stirred for 12 hours to dissolve. Furthermore, 65 g of acetylene black (DENKA BLACK HS-100, manufactured by Denki Kagaku Kogyo Kabushiki Kaisha) was added to the mixture and further stirred for 12 hours to produce a current collector surface treatment composition 1. This electric conductive composition 1 was coated on an aluminum current collector foil in a. manner so that the thickness after being dried was 0.5 μm and dried at 120° C. for 10 minutes. This is an example of a lithium ion secondary battery produced in the same manner as in Comparative Example 13 except for using this current collector.

### Comparative Example 15

This is an example of a lithium ion secondary battery produced in the same manner except for producing a current collector surface treatment composition 2 using polyvinyl alcohol of Comparative Example 4 in place of poly(vinyl alcohol/butyl vinyl ether) copolymer of Example 40.

### Production of Lithium Secondary Battery (Coating Layer Formed on Separator)/Examples 41 and 42 and Comparative Example 16

### Example 41

A composition 12 was obtained in the same manner as for the composition 1 of Example 9 except for adding 0.1 kg of a silane coupling agent (KBM-403, manufactured by Shin-Etsu Chemical Co., Ltd.) in addition to the 10 L of ion-exchanged water in a 100 L tank made of polypropylene, stirring for 10 minutes, and then adding the alumina. This is an example of a lithium ion secondary battery produced in the same manner as in Example 30 except for using the composition 12.

### Example 42

In a 100 L tank made of polypropylene, 10 L of ion-exchanged water and 0.1 kg of a silane coupling agent (KBM-403, manufactured by Shin-Etsu Chemical Co., Ltd.) were added, then 10 kg of alumina particles was added and stirred for 12 hours to produce a 50% dispersion. Thereafter, the mixture was heated and dried using an oven at 150° C. for 24 hours. The resultant dried material was then stirred for 12 hours using a stirring grinder (model: 6R B type, manufactured by Ishikawa Kojo Co., Ltd.) to obtain a surface treated alumina. A composition 13 was obtained in the same manner as for the composition 1 of Example 9 except for using the surface treated alumina as the alumina particles. This is an example of a lithium ion secondary battery produced in the same manner as in Example 30 except for using the composition 13.

### Comparative Example 16

This is an example of a lithium ion secondary battery produced in the same manner as in Example 30 except for producing a composition 14 using an acrylic copolymer (POVACOAT Type F, manufactured by Daido Chemical Corporation) in place of poly(vinyl alcohol/butyl vinyl ether) copolymer of Example 35.

The following characteristics were measured for lithium ion secondary batteries of Examples and Comparative Examples.

Measurement of Initial Capacity

To determine an initial capacity, charging was performed at a constant current of 0.01 mA until the voltage became 4.2 V, and then charging was performed at a constant voltage of 4.2 V for 2 hours. Thereafter, discharging was performed at a constant current of 0.01 mA until the voltage became 3.5 V. A series of the above operations was repeated three times, and the discharge capacity at the third cycle was taken as an initial capacity.

Rate Characteristics

Discharge rates were individually determined from the initial capacity, and a discharge capacity was measured for each of the discharge rates. In each charging operation, charging was performed at a constant current over 10 hours until the voltage was increased to 4.2 V, and then charging was performed at a constant voltage of 4.2 V for 2 hours. Thereafter, discharging was performed at a constant current over 10 hours until the voltage became 3.5 V, and the discharge capacity obtained at that time was taken as a discharge capacity for 0.1 C. Next, the same charging operation was performed, and then discharging was performed at a current at which discharging was completed in one hour based on the discharge capacity determined for 0.1 C, and the discharge capacity determined at that time was taken as a discharge capacity for 1 C. Similarly, discharge capacities for 3 C, 5 C, and 10 C were individually determined, and, taking the discharge capacity for 0.1 C as 100%, a capacity retention ratio was calculated.

Cycle Life

A charge and discharge test in which charging was performed at 1 C until the voltage became 4.2 V and charging was performed at a constant voltage of 4.2 V for 2 hours and then discharging was performed at 1 C until the voltage became 3.5 V was performed. Here, a percentage of the discharge capacity after 500 cycles relative to that in the first discharge was calculated.

Peeling Properties

As a test method, the battery obtained after the test was disassembled to examine the state of the inside. Evaluation criteria were as follows.

⊚: No peeling was observed.

◯: A partial peeling was observed; however, the current collector (or the separator, in the case of separator coating) was not exposed.

Δ: Peeling proceeded, and a part of the current collector (or the separator, in the case of separator coating) was exposed.

X: The current collector was in contact, and short circuit occurred.

Water Content

As a test method, each of the compositions was cast on a polyethylene terephthalate film in a manner that the film thickness after drying was 50 μm, and dried at 60° C. for 1 hour. Thereafter, the resultant material was cut into a shape in which each side was 10 mm, and the water content of 20 pieces of these test pieces was determined. The water content was determined by measuring heated and vaporized water using a coulometric Karl Fischer titration. The heating condition was at 150° C. for 10 minutes, and CA-200 manufactured by Mitsubishi Chemical Analytech Co., Ltd. was used as the Karl Fischer moisture meter. In the table, the water contents written for Examples 18 to 38, Examples 41 and 42, and Comparative Examples 4 to 12, 15, and 16 correspond to the water contents measured using the method described above for the compositions 1 to 6, and 10 to 14. The water content written for Example 39 corresponds to the water content for the case where the active material layer composition 2 was used. The water contents written for Example 40 and Comparative Example 15 correspond to the water contents for the cases where the current collector surface treatment compositions 1 and 2, respectively, were used. Note that the water contents written for Comparative Examples 13 and 14 correspond to the water contents for the cases where the active material layer composition 1 (used in the production of the positive electrode active material layer. See Example 18) was used.

TABLE 2-1

| Example | Composition | Compound name of binder | Type | Coated part |
|---|---|---|---|---|
| Example 18 | Composition 1 | Poly(vinyl alcohol/butyl vinyl ether) | For heat resistant | Negative electrode |
| | | | coating layer | was coated |
| Example 19 | Composition 2 | Poly(vinyl alcohol/butyl allyl ether) | For heat resistant | Negative electrode |
| | | | coating layer | was coated |
| Example 20 | Composition 3 | Poly(vinyl alcohol/(2-ethylhexyl vinyl ether)) | For heat resistant | Negative electrode |
| | | | coating layer | was coated |
| Example 21 | Composition 4 | Poly(vinyl alcohol/hexene) | For heat resistant | Negative electrode |
| | | | coating layer | was coated |
| Example 22 | Composition 5 | Poly(vinyl alcohol/cyclohexyl vinyl ether) | For heat resistant | Negative electrode |
| | | | coating layer | was coated |
| Example 23 | Composition 6 | Poly(vinyl alcohol/ethyl vinyl sulfide) | For heat resistant | Negative electrode |
| | | | coating layer | was coated |
| Example 24 | Composition 1 | Poly(vinyl alcohol/butyl vinyl ether) | For heat resistant | Positive electrode |
| | | | coating layer | was coated |
| Example 25 | Composition 2 | Poly(vinyl alcohol/butyl allyl ether) | For heat resistant | Positive electrode |
| | | | coating layer | was coated |
| Example 26 | Composition 3 | Poly(vinyl alcohol/(2-ethylhexyl vinyl ether)) | For heat resistant | Positive electrode |
| | | | coating layer | was coated |
| Example 27 | Composition 4 | Poly(vinyl alcohol/hexene) | For heat resistant | Positive electrode |
| | | | coating layer | was coated |
| Example 28 | Composition 5 | Poly(vinyl alcohol/cyclohexyl vinyl ether) | For heat resistant | Positive electrode |
| | | | coating layer | was coated |
| Example 29 | Composition 6 | Poly(vinyl alcohol/ethyl vinyl sulfide) | For heat resistant | Positive electrode |
| | | | coating layer | was coated |
| Example 30 | Composition 1 | Poly(vinyl alcohol/butyl vinyl ether) | For heat resistant | Separator was |
| | | | coating layer | coated |
| Example 31 | Composition 2 | Poly(vinyl alcohol/butyl allyl ether) | For heat resistant | Separator was |
| | | | coating layer | coated |
| Example 32 | Composition 3 | Poly(vinyl alcohol/(2-ethylhexyl vinyl ether)) | For heat resistant | Separator was |
| | | | coating layer | coated |
| Example 33 | Composition 4 | Poly(vinyl alcohol/hexene) | For heat resistant | Separator was |
| | | | coating layer | coated |
| Example 34 | Composition 5 | Poly(vinyl alcohol/cyclohexyl vinyl ether) | For heat resistant | Separator was |
| | | | coating layer | coated |
| Example 35 | Composition 6 | Poly(vinyl alcohol/ethyl vinyl sulfide) | For heat resistant | Separator was |
| | | | coating layer | coated |

| | | | | | | | Cycle life | | |
|---|---|---|---|---|---|---|---|---|---|
| | | Initial | Rate characteristics: | | | | Capacity retention | | Water |
| | Form of used | capacity | capacity retention ratio [%] | | | | ratio at 500th | Peeling | content |
| Example | separator | [mAh] | 1 C | 3 C | 5 C | 10 C | cycle [%] | properties | ppm |
| Example 18 | Microporous | 10.2 | 97 | 87 | 74 | 27 | 89 | ◯ | 3800 |
| | membrane | | | | | | | | |
| Example 19 | Microporous | 10.2 | 97 | 87 | 74 | 27 | 89 | ◯ | 3600 |
| | membrane | | | | | | | | |
| Example 20 | Microporous | 10.2 | 98 | 88 | 76 | 28 | 90 | ◯ | 3500 |
| | membrane | | | | | | | | |
| Example 21 | Microporous | 10.1 | 97 | 86 | 75 | 25 | 87 | Δ | 3400 |
| | membrane | | | | | | | | |
| Example 22 | Microporous | 10.1 | 97 | 86 | 76 | 26 | 89 | Δ | 3200 |
| | membrane | | | | | | | | |
| Example 23 | Microporous | 10.0 | 96 | 85 | 73 | 24 | 85 | Δ | 3900 |
| | membrane | | | | | | | | |
| Example 24 | Microporous | 10.0 | 97 | 87 | 74 | 27 | 89 | ◯ | 3800 |
| | membrane | | | | | | | | |
| Example 25 | Microporous | 10.2 | 97 | 87 | 74 | 27 | 89 | ◯ | 3600 |
| | membrane | | | | | | | | |
| Example 26 | Microporous | 10.2 | 98 | 88 | 75 | 27 | 90 | ◯ | 3500 |
| | membrane | | | | | | | | |
| Example 27 | Microporous | 10.2 | 97 | 85 | 75 | 28 | 88 | Δ | 3400 |
| | membrane | | | | | | | | |
| Example 28 | Microporous | 10.1 | 97 | 85 | 76 | 26 | 89 | Δ | 3200 |
| | membrane | | | | | | | | |
| Example 29 | Microporous | 10.1 | 95 | 85 | 73 | 24 | 86 | Δ | 3900 |
| | membrane | | | | | | | | |
| Example 30 | Microporous | 10.1 | 97 | 88 | 75 | 27 | 90 | ◯ | 3800 |
| | membrane | | | | | | | | |
| Example 31 | Microporous | 10.1 | 97 | 88 | 75 | 27 | 90 | ◯ | 3600 |
| | membrane | | | | | | | | |
| Example 32 | Microporous | 10.2 | 98 | 88 | 77 | 28 | 90 | ⊚ | 3500 |
| | membrane | | | | | | | | |
| Example 33 | Microporous | 10.0 | 96 | 86 | 74 | 26 | 87 | Δ | 3400 |
| | membrane | | | | | | | | |
| Example 34 | Microporous | 10.0 | 96 | 86 | 75 | 26 | 88 | Δ | 3200 |
| | membrane | | | | | | | | |
| Example 35 | Microporous | 10.0 | 95 | 85 | 73 | 24 | 84 | Δ | 3900 |
| | membrane | | | | | | | | |

TABLE 2-2

| Example | Composition | Compound name of binder | Type | Coated part |
|---|---|---|---|---|
| Example 36 | Composition 1 | Poly(vinyl alcohol/butyl vinyl ether) | For heat resistant | Negative electrode |
| | | | coating layer | was coated |
| Example 37 | Composition 1 | Poly(vinyl alcohol/butyl vinyl ether) | For heat resistant | Positive electrode |
| | | | coating layer | was coated |
| Example 38 | Composition 1 | Poly(vinyl alcohol/butyl vinyl ether) | For heat resistant | Separator was |
| | | | coating layer | coated |
| Example 4 | Composition 10 | Polyvinyl alcohol | For heat resistant | Negative electrode |
| | | | coating layer | was coated |
| Example 5 | Composition 11 | Polyvinylidene fluoride | For heat resistant | Negative electrode |
| | | | coating layer | was coated |
| Example 6 | Composition 10 | Polyvinyl alcohol | For heat resistant | Positive electrode |
| | | | coating layer | was coated |
| Example 7 | Composition 11 | Polyvinylidene fluoride | For heat resistant | Positive electrode |
| | | | coating layer | was coated |
| Example 8 | Composition 10 | Polyvinyl alcohol | For heat resistant | Separator was |
| | | | coating layer | coated |
| Example 9 | Composition 11 | Polyvinylidene fluoride | For heat resistant | Separator was |
| | | | coating layer | coated |
| Example 10 | Composition 10 | Polyvinyl alcohol | For heat resistant | Negative electrode |
| | | | coating layer | was coated |
| Example 11 | Composition 10 | Polyvinyl alcohol | For heat resistant | Positive electrode |
| | | | coating layer | was coated |
| Example 12 | Composition 10 | Polyvinyl alcohol | For heat resistant | Separator was |
| | | | coating layer | coated |
| Example 13 | — | None | — | No treatment |
| Example 14 | — | None | — | No treatment |
| Example 39 | Active material layer | Poly(vinyl alcohol/butyl vinyl ether) | For active material | Positive electrode |
| | composition 2 | | layer | current collector |
| Example 40 | Current collector | Poly(vinyl alcohol/butyl vinyl ether) | For current collector | Positive electrode |
| | surface treatment | | surface treatment | current collector |
| | composition 1 | | | |
| Example 41 | Composition 12 | Poly(vinyl alcohol/butyl vinyl ether) | For heat resistant | Separator was |
| | | | coating layer | coated |
| Example 42 | Composition 13 | Poly(vinyl alcohol/butyl vinyl ether) | For heat resistant | Separator was |
| | | | coating layer | coated |
| Example 15 | Current collector | Polyvinylidene fluoride | For current collector | Positive electrode |
| | surface treatment | | surface treatment | current collector |
| | composition 2 | | | |
| Example 16 | Composition 14 | Acrylic copolymer | For heat resistant | Separator was |
| | | | coating layer | coated |

| | | | | | | | Cycle life | | |
|---|---|---|---|---|---|---|---|---|---|
| | | Initial | Rate characteristics: | | | | Capacity retention | | Water |
| | Form of used | capacity | capacity retention ratio [%] | | | | ratio at 500th | Peeling | content |
| Example | separator | [mAh] | 1 C | 3 C | 5 C | 10 C | cycle [%] | properties | ppm |
| Example 36 | Nonwoven | 10.0 | 97 | 86 | 75 | 27 | 89 | ◯ | 3800 |
| | fabric | | | | | | | | |
| Example 37 | Nonwoven | 10.0 | 97 | 88 | 75 | 28 | 90 | ◯ | 3800 |
| | fabric | | | | | | | | |
| Example 38 | Nonwoven | 10.2 | 97 | 87 | 76 | 28 | 89 | ◯ | 3800 |
| | fabric | | | | | | | | |
| Example 4 | Microporous | 10.2 | 97 | 87 | 74 | 27 | 85 | Δ | 4800 |
| | membrane | | | | | | | | |
| Example 5 | Microporous | 10.1 | 97 | 85 | 74 | 25 | 40 | X | 4100 |
| | membrane | | | | | | | | |
| Example 6 | Microporous | 10.2 | 97 | 87 | 74 | 27 | 85 | Δ | 4800 |
| | membrane | | | | | | | | |
| Example 7 | Microporous | 10.1 | 97 | 86 | 73 | 26 | 40 | X | 4100 |
| | membrane | | | | | | | | |
| Example 8 | Microporous | 10.2 | 97 | 87 | 75 | 28 | 85 | Δ | 4800 |
| | membrane | | | | | | | | |
| Example 9 | Microporous | 10.1 | 97 | 85 | 72 | 25 | 72 | Δ | 4100 |
| | membrane | | | | | | | | |
| Example 10 | Nonwoven | 10.0 | 97 | 85 | 72 | 25 | 83 | Δ | 4800 |
| | fabric | | | | | | | | |
| Example 11 | Nonwoven | 10.0 | 97 | 85 | 71 | 23 | 81 | Δ | 4800 |
| | fabric | | | | | | | | |
| Example 12 | Nonwoven | 10.1 | 97 | 84 | 73 | 24 | 81 | Δ | 4800 |
| | fabric | | | | | | | | |
| Example 13 | Microporous | 10.4 | 98 | 90 | 82 | 30 | 85 | — | 3800 |
| | membrane | | | | | | | | |
| Example 14 | Nonwoven | 10.2 | 97 | 88 | 80 | 30 | 83 | — | 3800 |
| | fabric | | | | | | | | |
| Example 39 | Microporous | 11.2 | 98 | 92 | 85 | 36 | 89 | ◯ | 3000 |
| | membrane | | | | | | | | |
| Example 40 | Microporous | 10.8 | 98 | 92 | 86 | 45 | 88 | ⊚ | 2800 |
| | membrane | | | | | | | | |
| Example 41 | Microporous | 10.4 | 98 | 89 | 77 | 29 | 91 | ⊚ | 3000 |
| | membrane | | | | | | | | |
| Example 42 | Microporous | 10.5 | 98 | 90 | 79 | 35 | 92 | ⊚ | 2500 |
| | membrane | | | | | | | | |
| Example 15 | Microporous | 10.5 | 97 | 91 | 83 | 34 | 86 | Δ | 3100 |
| | membrane | | | | | | | | |
| Example 16 | Microporous | 10.3 | 97 | 82 | 68 | 12 | 76 | Δ | 5800 |
| | membrane | | | | | | | | |

### INDUSTRIAL APPLICABILITY

Since the present invention provides a binder capable of forming a layer that has low water content and that does not reduce high-speed charge/discharge characteristics of a non-aqueous electricity storage element while enhancing adhesive properties with respect to a substrate such as an electrode, separator, or current collector, the present invention is highly, industrially applicable.

### REFERENCE SIGNS LIST

1 Coating layer
2 Active material layer
3 Current collector
4 Coating layer
5 Separator

1. A binder for a non-aqueous electricity storage element comprising a polymer represented by formula (1): 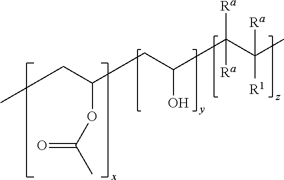
wherein, R¹ independently represents an alkyl group that is unsubstituted or substituted with a halogen atom and/or a hydroxy group and that has 1 to 40 carbon atoms, wherein —CH₂— in the alkyl group may be substituted with a group selected from an oxygen atom, sulfur atom, or cycloalkanediyl; or represents a group represented by —OR², wherein R² is a monovalent group of a 3 to 10 membered carbocyclic ring or heterocycle; when a sum of x, y, and z is 1, 0≦x<1, 0≦y<1, and 0<z<1 are satisfied, and units shown in parentheses having x, y, or z may be present in a block or present randomly; and R^{a} is independently a hydrogen atom or fluorine atom.

2. The binder for a non-aqueous electricity storage element according to claim 1, wherein R¹ in formula (1) is a group represented by —(CH₂)ₘ—O—(CH₂)ₙ—CH₃, wherein, m is any integer of 0 to 3, and n is any integer of 0 to 10.

3. The binder for a non-aqueous electricity storage element according to claim 1, wherein R¹ in formula (1) is a group represented by —(CH₂)ₘ—O—(CH₂)ₙ—(CH—(CH₂)ₕCH₃)—(CH₂)ₖ—CH₃ wherein, m is any integer of 0 to 3, n is any integer of 0 to 10, h is any integer of 0 to 10, and k is any integer of 0 to 10.

4. The binder for a non-aqueous electricity storage element according to claim 1, wherein R¹ in formula (1) is a group represented by —(CH₂)ₙ—CH₃, wherein n is any integer of 0 to 10.

5. The binder for a non-aqueous electricity storage element according to claim 1, wherein R¹ in formula (1) is —OR², and R² is a group represented by the following formula: 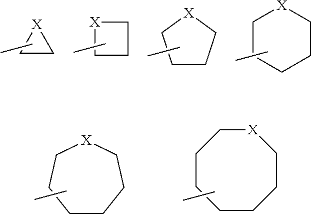
wherein, X is —CH₂—, —NH—, —O—, or —S—.

6. The binder for a non-aqueous electricity storage element according to claim 1, wherein R¹ in formula (1) is a group represented by —(CH₂)ₘ—S—(CH₂)ₙ—CH₃ wherein, m is any integer of 0 to 3, and n is any integer of 0 to 10.

7. The binder for a non-aqueous electricity storage element according to claim 1, the binder further comprising 1 to 10000 ppm of at least one type selected from the group consisting of sodium, lithium, potassium, and ammonia.

8. The binder for a non-aqueous electricity storage element according to claim 1, the binder further comprising a coupling agent.

9. An electrode for a non-aqueous electricity storage element comprising a coating layer formed by using the binder for a non-aqueous electricity storage element according to claim 1.

10. An electrode for a non-aqueous electricity storage element comprising an active material layer formed by using the binder for a non-aqueous electricity storage element according to claim 1.

11. A separator for a non-aqueous electricity storage element comprising a coating layer formed by using the binder for a non-aqueous electricity storage element according to claim 1.

12. A current collector for a non-aqueous electricity storage element comprising a coating layer formed by using the binder for a non-aqueous electricity storage element according to claim 1.

13. A non-aqueous electricity storage element comprising the electrode for a non-aqueous electricity storage element according to claim 9.

14. A non-aqueous electricity storage element comprising the electrode for a non-aqueous electricity storage element according to claim 10.

15. A non-aqueous electricity storage element comprising the separator for a non-aqueous electricity storage element according to claim 11.

16. A non-aqueous electricity storage element comprising the current collector for a non-aqueous electricity storage element according to claim 12.

17. A method for producing an electrode for a non-aqueous electricity storage element, the method comprising applying the binder for a non-aqueous electricity storage element according to claim 1 on an active material layer that is disposed on a current collector.

18. A method for producing an electrode for a non-aqueous electricity storage element, the method comprising applying a composition on a current collector, wherein the composition comprises the binder for a non-aqueous electricity storage element according to claim 1 and an active material.

19. A method for producing a separator for a non-aqueous electricity storage element, the method comprising applying the binder for a non-aqueous electricity storage element according to claim 1 on a porous membrane or on a nonwoven fabric.

20. A method for producing a current collector for a non-aqueous electricity storage element, the method comprising applying the binder for a non-aqueous electricity storage element according to claim 1 on a metal foil.
